(19) United States
(12) Patent Application Publication
(10) Pub. No.: US 2016/0006829 A1
(43) Pub. Date: Jan. 7, 2016

(54) DATA MANAGEMENT SYSTEM AND DATA MANAGEMENT METHOD

(71) Applicant: HITACHI, LTD., Chiyoda-ku, Tokyo (JP)

(72) Inventors: Yohsuke ISHII, Tokyo (JP); Masakuni AGETSUMA, Tokyo (JP); Masanori TAKATA, Tokyo (JP); Shoji KODAMA, Tokyo (JP)

(73) Assignee: HITACHI, LTD., Tokyo (JP)

(21) Appl. No.: 14/768,491

(22) PCT Filed: Oct. 2, 2013
(86) PCT No.: PCT/JP2013/076875

§ 371 Date: Aug. 18, 2015

(51) Int. Cl. H04L 29/08

(52) U.S. Cl. CPC H04L 67/2842; H04L 67/1097

(57) ABSTRACT

A second storage unit stores a first piece of data and second pieces of data. Each of first storage units holds configuration information indicating association between the first piece of data and the second pieces of data associated by first computers. Each of the first computers receives a second piece of data and register information of the received second piece of data in the configuration information, instructs a second computer to store the received second piece of data in association with the first piece of data, and identifies a second piece of data to be acquired from the second computer based on the configuration information in acquiring the second piece of data. The second computer, in accordance with instructions from the first computers, stores the second pieces of data in the second storage unit in association with the first piece of data.

### BACKGROUND

The present invention relates to a data management system.

In recent years, the number of pieces of data stored in a computer system is increasing. The cost of computing resources is decreasing, and approaches are implemented to analyze a large amount of data with ample computing resources and utilize the data based on the analysis result.

In some cases, data analysis analyzes target data itself. In other cases, data analysis extracts or creates metadata characterizing target data from the target data and analyzes the target data using the metadata.

In order to implement the latter, it is important for a computer system to achieve following things in terms of cost, availability and performance.

The first thing is to manage metadata in association with original data from which the metadata is extracted and manage a large amount of metadata efficiently. The second thing is to receive metadata at any time without predefining the viewpoint for extracting metadata from data, and manage data and metadata in association with each other. The third thing is to create metadata in multiple view points and allow the created pieces of data from a plurality of sites concurrently.

A method for managing a large amount of data cost efficiently is proposed in a conventional hierarchical storage system (for example, Patent Literature 1). The technique disclosed in Patent Literature 1 allows a computer system hierarchical management of data and associated metadata, thereby allowing the stored data and metadata to be referred from a plurality of sites.

Patent Literature 1: U.S. Pat. No. 8,170,990B2

### SUMMARY

In application of the technique of Patent Literature 1, it is necessary to prescribe the format of metadata in advance. Thus, it cannot manage metadata whose format is customized by a user without restraint (custom metadata, hereinafter). Further, it cannot add and update metadata associated with data by a plurality of sites.

A purpose of the present invention is to provide a system allowing metadata customizable by a plurality of sites to be shared with ease among the plurality of sites.

A representative embodiment of the present invention is a data management system for managing data stored in computers including: a plurality of first computers comprising first processors and first storage units; and a second computer comprising a second processor and a second storage unit, wherein the second storage unit is configured to store a first piece of data and a plurality of second pieces of data, wherein each of the first storage units is configured to hold configuration information indicating association between the first piece of data and the plurality of second pieces of data associated by the plurality of first computers, wherein each of the first computers is configured to receive a second piece of data and register information of the received second piece of data in the configuration information, wherein each of the first computers is configured to instructs the second computer to store the received second piece of data in association with the first piece of data, wherein the second computer is configured to, in accordance with the plurality of first computers, store the plurality of second pieces of data in the second storage unit in association with the first piece of data, and wherein, each of the first computers is configured to identify a second piece of data to be acquired from the second computer based on the configuration information in acquiring the second piece of data.

An embodiment of the present invention allows metadata customizable by a plurality of sites to be shared with ease among the plurality of sites.

Objects, configurations, and effects of this invention other than those described above will be clarified in the description of the following embodiments

### BRIEF DESCRIPTION OF THE DRAWINGS

FIG. 1 is an explanatory drawing depicting the outline of a process by a computer system according to Embodiment 1;

FIG. 2 is a block diagram depicting configuration of devices employed in the computer system according to Embodiment 1;

FIG. 3 is an explanatory drawing depicting a directory configuration table according to Embodiment 1;

FIG. 4 is an explanatory drawing depicting a stub file management table according to Embodiment 1;

FIG. 5 is an explanatory drawing depicting an ownership management table according to Embodiment 1;

FIG. 6 is an explanatory drawing depicting a metadata management table according to Embodiment 1;

FIG. 7 is a flowchart depicting a file registration process according to Embodiment 1;

FIG. 8 is a flowchart depicting a file backup process according to Embodiment 1;

FIG. 9 is a flowchart depicting a file recall process according to Embodiment 1;

FIG. 10 is a flowchart depicting a file restoration process according to Embodiment 1;

FIG. 11 is a flowchart depicting a process for updating directory configuration information held in an object according to Embodiment 1;

FIG. 12 is an explanatory drawing depicting a setting window according to Embodiment 1;

FIG. 13 is an explanatory drawing depicting the outline of a process by a computer system according to Embodiment 2;

FIG. 14 is a block diagram depicting the configuration of the computer system according to Embodiment 2;

FIG. 15 is an explanatory drawing depicting a management window according to Embodiment 2;

FIG. 16 is a flowchart depicting an ingestion process according to Embodiment 2;

FIG. 17 is a flowchart depicting an access process to actual data according to Embodiment 2; and

FIG. 18 is a flowchart depicting an access process to metadata according to Embodiment 2.

### DETAILED DESCRIPTION OF THE EMBODIMENTS

Hereinafter, embodiments for implementing the present invention will be described in detail.

### Embodiment 1

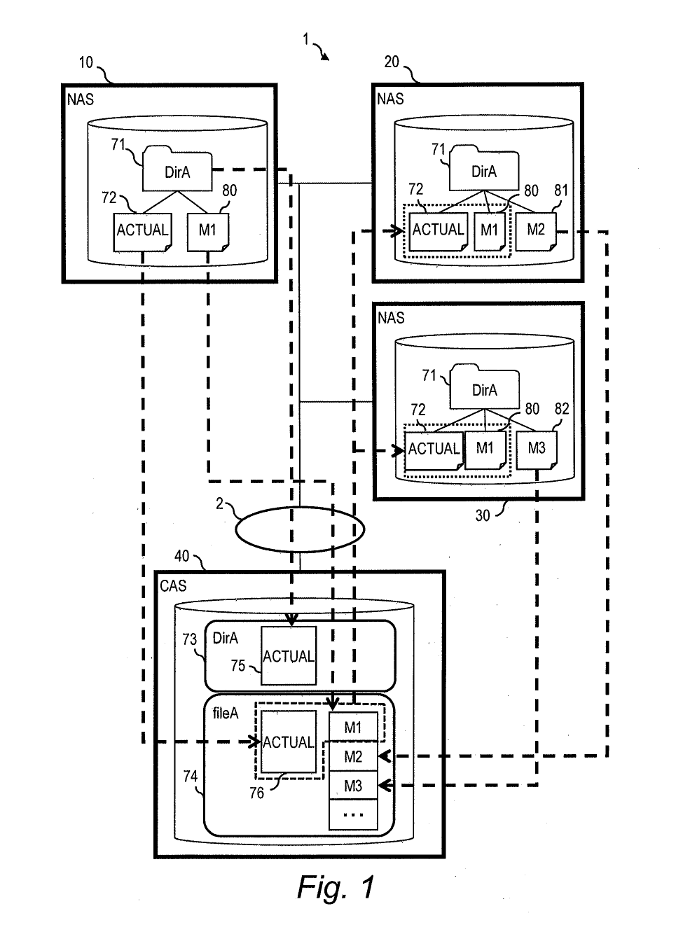

FIG. 1 is an explanatory drawing depicting the outline of a process by a computer system 1 according to Embodiment 1.

The computer system 1 according to Embodiment 1 includes a plurality of network-attached storages (NASs) 10, 20 and 30, which are file servers managing data in units of files. The computer system 1 according to Embodiment 1 includes a content-addressable storage (CAS) 40

The NAS 10, NAS 20, NAS 30 and CAS 40 are connected via a network 2 and communicate data with each other. Each of the NAS 10, NAS 20 and NAS 30 provides a file storing service and a file sharing service.

The file storing service according to the present embodiment allows a user to store data files to any one of the NAS 10, NAS 20 and NAS 30. The file sharing service according to the present embodiment allows any one of the NAS 10, NAS 20 and NAS 30 to read a file stored in any one of the NAS 10, NAS 20 and NAS 30.

The NAS 10, NAS 20 and NAS 30 have the same functions. Hereinafter, a common function or process among the NAS 10, NAS 20 and NAS 30 is described as a function of process of a NAS.

The NASs and CAS 40 configure hierarchical storage. The NASs and CAS 40 provide a file archive service and a file sharing service among sites.

The file archive service and file sharing service among sites according to the present embodiment provide a function to replicate or migrate a file stored in the NAS to the CAS 40, a function to restore a file stored in CAS 40 to the NAS where the file was stored at first, and a function replicate a file from the CAS 40 to a plurality of NASs.

The NAS according to the present embodiment provides a metadata storing service in addition to the file storing service and file sharing service. The metadata storing service according to the present embodiment manages the actual data and metadata of a file stored in the NAS in association with each other, and provide metadata as a file as well as actual data.

The actual data in the present embodiment is data shred among a plurality of NASs. A piece of metadata in the present embodiment is created in association with a piece of actual data, and the plurality of NASs can add, update and delete the piece of metadata in accordance with the piece of actual data.

A file system of the NAS 10 creates a directory 71 (Dir A), a file 72 and a file 80. The directory 71 (Dir A) contains the file 72 (file A) and the file 80.

The file 72 is a file for providing actual data. The file 80 is a file for providing metadata M1. Hereinafter, a file for providing actual data is described as an actual data file and a file for providing metadata is described as a metadata file.

The NAS 10 stores the file 72 and the file 80 in the directory 71 created arbitrarily using the file system. Thereby, the NAS 10 holds the association relation between the file 72 and the file 80.

The computer system 1 according to the present embodiment provides a metadata sharing service, a metadata archive service and a metadata sharing among sites service for metadata stored in file format.

Specifically, the CAS 40 is equipped with an object management function to manage data in units of objects. An object in the CAS 40 holds an actual data storage area managing the contents of actual data and a metadata storage area managing the contents of metadata. The metadata storage area in the object may have a plurality of entries.

The CAS 40 stores the files 72 and 80 stored in the NAS 10 in an object 74 (file A) using the object management function. The CAS 40 stores the actual data corresponding to the file 72 in an actual data storage area 76 of the object 74 and metadata M1 corresponding to the file 80 in a metadata storage area of the object 74.

After storing data in the CAS 40, the NAS 10, if necessary, may perform a stub process on the file whose data is stored in the CAS 40. The stub process according to the present embodiment replaces information indicating the location of data stored in a file with storage location information indicating the storage location of data in the CAS 40, and deletes the information other than the storage location information contained in the file. A file on which the stub process has been performed is called a stub file in the present embodiment.

In the present embodiment, the stub process is also performed on a directory. Specifically, the NAS stores the information identifying files and subdirectories contained in the directory in the CAS 40. Subsequently, in the stub process on the directory, the NAS stores only the storage location information in the CAS 40 into a directory in the NAS.

When the NAS 10 receives an access request for referring to a stub file, the NAS 10 reads (recalls) data corresponding to the stub file from the CAS 40. The NAS 10 associates the read data with the stub file to return the stub file to a usual file and has the usual file accessed from the source of the access request.

The stub process makes it unnecessary for the NAS 10 according to the present embodiment to hold data all the time, resulting in the efficient storage utilization.

The computer system 1 according to the present embodiment stores data of a directory as well as a file in the NAS 10 into an object of the CAS 40. FIG. 1 shows that data of the directory 71 the NAS 10 holds is stored in the actual data storage area 75 in the object 73 (Dir A) the CAS 40 holds.

The NAS 20 and the NAS 30 according to the present embodiment can refer to the file 72 and the file 80 using the object stored in the CAS 40. The NAS 20 and the NAS 30 are NASs other than the NAS 10 and the NAS 10 is a NAS in which the file 72 and the file 80 were stored at first.

Specifically, when the NAS 20 or the NAS 30 receives an access request for referring to the file 72 or the file 80, the NAS 20 or the NAS 30 identifies the object associated with the file path name indicated by the access request in the CAS 40 (object 74 in FIG. 1). The CAS 40 transmits the actual data or the metadata stored in the identified object 74 to the NAS 20 or the NAS 30.

When a plurality of NASs refer to one actual data file, each of the plurality of NASs creates metadata arbitrarily. The CAS 40 associates the metadata created by the plurality of NASs with the actual data of the referred actual data file and add it to the object.

Specifically, the NAS 20 creates metadata M2 associated with the actual data of the file 72 and creates a file 81 (M2) providing the metadata M2. The NAS 30 creates metadata M3 associated with the actual data of the file 72 and creates a file 82 (M3) providing the metadata M3.

The CAS 40 stores the metadata M2 or the metadata M3 in the metadata storage area of the object 74. After stored in the CAS 40, the metadata M2 or the metadata M3 is referred from all of the NAS 10, NAS 20 and NAS 30 in common with the metadata M 1.

The computer system 1 according to the present embodiment is equipped with the following functions for providing the above services.

The first function is that the NAS holds the association relation between actual data and metadata associated with the actual data.

The second function is that the NAS receives an access request for referring to the actual data and the metadata with an existing file I/F.

The third function is that, when the NAS sends data to the CAS 40, the NAS transmits the association information between the actual data and the metadata to the CAS 40.

The fourth function is that, when a NAS other than the NAS with which the actual data and the metadata are associated receives an access request for referring to the data stored in the CAS 40, the NAS retrieves the actual data or the metadata from the CAS 40 while sustaining the association between the actual data and the metadata.

The fifth function is a function to store metadata created by a plurality of NASs in association with actual data stored in the CAS 40 into the CAS 40 concurrently.

In conventional techniques (the technique disclosed in Patent Literature 1, for example), it is possible to add or update metadata itself in an atomic manner; however, it is impossible for a plurality of sites to update the configuration information of a directory storing metadata in an atomic manner. Therefore, the computer system 1 according to the present embodiment has a function to update the configuration information of a directory storing metadata from a plurality of sites.

Hereinbefore and hereinafter, a storage apparatus managing data in units of objects is described as the CAS 40. The CAS 40 is distinguished from the NAS. The computer system 1 according to the present embodiment may include a NAS equipped with the functions of the CAS 40. The computer system 1 according to the present embodiment may include another storage apparatus or software to provide the same functions as the CAS 40.

The NAS and the CAS 40 in the present embodiment manage data using files provided by a file system; however, any method to manage data may be employed of the method can manage a set of data having one meaning as one unit.

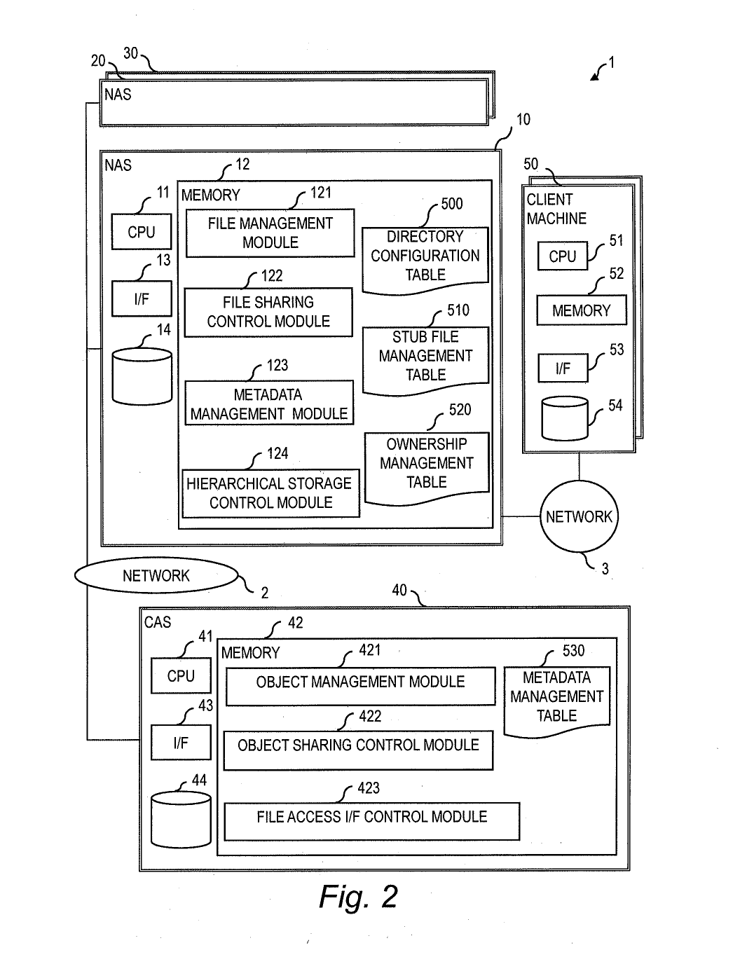

FIG. 2 is a block diagram depicting the configuration of apparatuses of the computer system 1 according to the present embodiment.

The computer system 1 illustrated in FIG. 2 includes a plurality of NASs (NAS 10, NAS 20 and NAS 30) and the CAS 40. The NASs and the CAS 40 are connected through the wired or wireless network 2 and can communicate data with one another.

Each of the NASs in the computer system 1 is connected with a corresponding local network 3. The network 3 is connected with one or more client machines 50 used by users of the NAS. The network 3 and the client machines 50 illustrated in FIG. 2 are connected with the NAS 10. The NAS 20 and the NAS 30 may be connected with networks and apparatuses corresponding to the network 3 and client machines 50.

Hereinafter, the configuration of the NAS 10 is described. The configuration of the NAS 10 described hereinafter is the configuration common to all of NASs.

The NAS 10 is implemented with a general server computer, for example, and includes CPU 11, memory 12, I/F 13 and auxiliary storage 14. The CPU 11 is a processing device. The CPU 11 may be any type of processing device with at least one processor.

The I/F 13 is an interface to control data communication with external apparatuses. The auxiliary storage 14 stores data.

In the memory 12, processing modules are developed by the CPU 11 executing programs. The processing modules developed in the memory 12 include a file management module 121, a file sharing control module 122, a metadata management module 123, and a hierarchical storage control module 124. Further, the memory 12 holds a directory configuration table 500, a stub file management table 510 and an ownership management table 520.

The file management module 121 provides a file system in the NAS 10. The file system by the file management module 121 creates a file in the auxiliary storage 14 for referring to data stored in the auxiliary storage 14. The file system by the file management module 121 adds, updates and deletes files stored in the auxiliary storage 14.

The file sharing control module 122 provides a control function for sharing a file stored in the auxiliary storage 14 among users. The file sharing control module 122 provides a file I/F such as Network File System (NFS) or Common Internet File System (CIFS).

The metadata management module 123 manages metadata associated with actual data by operating files provided by the file system. The metadata management module 123 holds the association relation between actual data and metadata. The function of the metadata management module 123 may be implemented aside from the file system or implemented as a function of the file management module 121.

The hierarchical storage control module 124 1 identifies a file whose data is to be replicated or moved to the CAS 40 in files stored in the auxiliary storage 14 and transfer the data of the identified file to the CAS 40. The hierarchical storage control module 124 performed the stub process on the file whose data has been transferred after transferring the data.

Upon receiving an access request for a stub file, the hierarchical storage control module 124 recalls the data of the stub file from the CAS 40 and converts the stub file to a usual file.

The directory configuration table 500, the stub file management table 510 and the ownership management table 520 will be described later.

The CAS 40 is implemented with a general server computer, for example, and includes CPU 41, memory 42, I/F 43 and auxiliary storage 44. The CPU 41 is a processing device. The CPU 41 may be any type of processing device with at least one processor.

The I/F 43 is an interface to control data communication with external apparatuses. The auxiliary storage 44 stores data.

In the memory 42, processing modules are developed by the CPU 41 executing programs. The processing modules developed in the memory 12 include an object management module 421, an object sharing control module 422, and a file access I/F control module 423. Further, the memory 42 holds a metadata management table 530.

The object management module 421 provides an object management system. The object management system manages objects stored in the CAS 40. The object management module 421 according to the present embodiment may use any type of system other than an object management system for managing actual data and metadata. For example, a file system or a database may be used for managing actual data and metadata.

The object sharing control module 422 provides a control function for share an object the CAS 40 has among a plurality of users.

The file access I/F control module 423 provides a function for the NAS to access an object of the CAS 40 using an I/F provided by the file sharing control module 122 of the NAS 10 for file access.

The metadata management table 530 will be described later.

The client machine 50 is implemented with a general server computer, for example, and includes CPU 51, memory 52, I/F 53 and auxiliary storage 54. The CPU 51 is a processing device. The CPU 51 may be any type of processing device with at least one processor.

The I/F 53 is an interface to control data communication with external apparatuses. The auxiliary storage 54 stores data.

In the memory 52, a processing module is developed by the CPU 51 executing programs. The processing module developed in the memory 52 is a file sharing client control module (not shown). The file sharing client control module is a processing module for a user to utilize the file sharing service provided by the NAS 10.

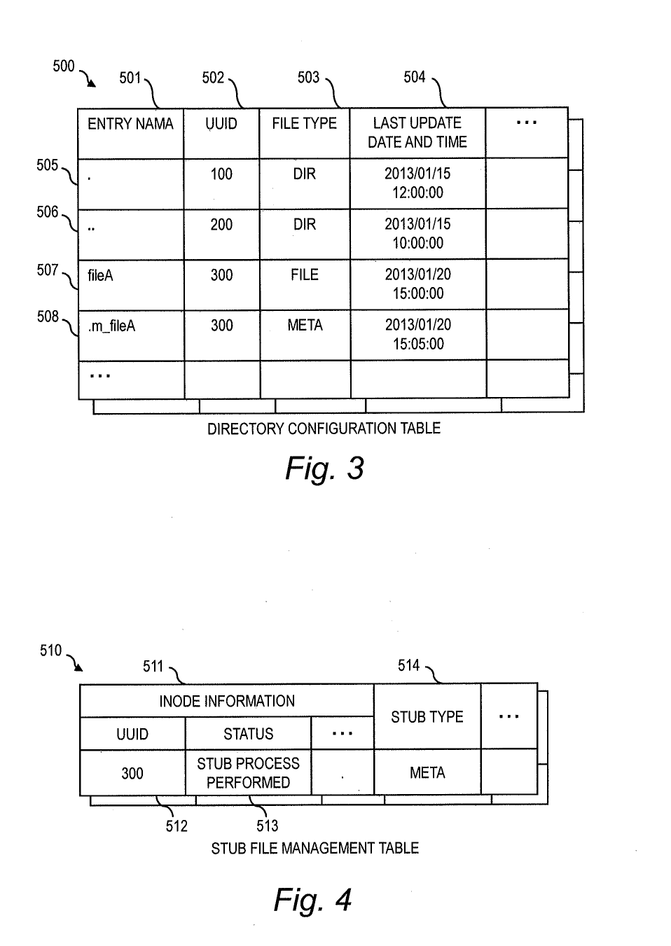

FIG. 3 is an explanatory drawing depicting the directory configuration table 500 according to Embodiment 1.

The NAS 10 holds a plurality of directory configuration tables 500 corresponding to directories provided by the file system, respectively. The directory configuration table 500 contains the information regarding files and subdirectories stored in the directory.

The directory configuration table 500 contains information of an entry name 501, a UUID 502, a file type 503 and a last update data and time 504 which are registered in association. The directory configuration table 500 illustrated in FIG. 3 contains entries 505 to 508.

The entry name 501 indicates identifiers of actual data files, metadata files and subdirectories stored in a directory. An identifier in the present embodiment may be represented by any code of English characters, numerals and symbols. In the present embodiment, an identifier of actual data file is described as an actual data file name, an identifier of metadata file is described as a metadata file name, and an identifier (path name) of directory is described as a directory name.

For example, “.” in the entry name 501 of the entry 505 indicates the directory itself corresponding to the directory configuration table 500. “..” in the entry name 501 of the entry 506 shown in FIG. 3 indicates the parent directory of the directory corresponding to the directory configuration table 500.

A metadata file name illustrated in FIG. 3 is defined using the actual data file name of the actual data file associated with the metadata file. Specifically, an identifier consisting of the associated actual data file name with the added prefix “.m” is defined as the metadata file name.

When it is necessary to identify pieces of metadata created by a plurality of NASs 10, an identifier consisting of the actual data file name with the added prefix “.m<NAS identifier>” may be defined as a metadata file name. The <NAS identifier> may include one or more characters and numerals to identify the corresponding NAS and may be any unique value defined in the computer system according to the present embodiment. For example, the <NAS identifier> of a NAS may be the address of the NAS.

The Universal Unique ID (UUID) 502 indicates identifiers of objects in the CAS 40 (UUID). A UUID indicated by the UUID 502 is a unique identifier in the computer system 1 according to the present embodiment.

When data of a file or a subdirectory stored in a directory is transferred to the CAS 40, the CAS 40 according to the present embodiment stores the transferred data of the file or the subdirectory in an object and assigns a UUID to the object.

After assigning a UUID to the object, the CAS 40 according to the present embodiment provides notification of the data file name stored in the object and the UUID to the NAS 10. The NAS 10 registers the notified UUID in the UUID 502.

The present embodiment assigns the same UUID to the associated actual data file and metadata file. This is because the associated actual data and metadata is stored in the same object. Thus, it is possible to determine whether an actual data file and a metadata file are associated by determining whether their UUIDs are the same.

An object of the present embodiment is created uniquely for each of actual data files and directories. The NAS may assign a UUID to a newly stored actual data file or directory. The NAS may notify the CAS 40 of the UUID assigned by itself and the actual data file name or the directory file name, and the CAS 40 may create an object based on the notified information. Hereinafter, the process in which the CAS 40 assigns UUIDs will be mainly described.

The file type 503 indicates an entry name indicated by the entry name 501 is an actual data file name, a metadata file name, or a directory name. In the present embodiment, when the entry name 501 indicates an actual data file, the file type 503 indicates “FILE”, and when the entry name 501 indicates a directory, the file type 503 indicates “DIR”. When the entry name 501 indicates a metadata file, the file type 503 indicates “META”.

The last update date and time 504 indicates the last update data and time of each entry.

The directory configuration table 500 illustrated in FIG. 3 holds information in table format. The directory configuration table 500 according to the present embodiment may hold the information in any type of format. For example, the NAS 10 may include the contents of the directory configuration table 500 in the mode information of a directory provided by the file system to hold it as the attribute information of directory or file. The NAS 10 may hold the contents of the directory configuration table 500 in a database.

The actual data storage area 75 included in the object 73 illustrated in FIG. 1 stores the contents equivalent to the directory configuration table 500. This is because the process described later stores the information created based on the actual data and metadata stored in the object 74 in the actual data storage area 75.

FIG. 4 is an explanatory drawing depicting the stub file management table 510 according to Embodiment 1.

The stub file management table 510 indicates whether the stub process has been performed on a file provided by the file system of the NAS 10. The stub file management table 510 contains the file attribute information.

The NAS 10 has the stub file management table 510 for each file provided by the file system. The stub file management table 510 contains information of an inode information 511 and a stub type 514 which are registered in association.

The inode information 511 includes the file attribute information, UUID 512 and status 513. The file attribute information in the present invention is the file attribute information provided by the operating system or input arbitrarily.

The UUID 512 indicates the UUID of the object in which the actual data or metadata corresponding to the stub file is stored in the CAS 40.

The status 513 indicates the transfer state indicating the data corresponding to the file has been transferred to the CAS 40 from the NAS 10, and the stub process has been performed on the file. For example, when the data associated with the file is not data to be transferred to the CAS 40, the status 513 indicates “NOT TO BE TRANSFERRED”. When the data corresponding to the file is data to be transferred but has not been transferred to the CAS 40, the status 513 indicates “NOT YET TRANSFERRED”.

When the data corresponding to the file is in transfer to the CAS 40, the status 513 indicates “IN TRANSFER”. When the data corresponding to the file has been transferred to the CAS 40 and the stub process is not performed yet, the status 513 indicates “TRANSFERRED”. When the stub process has been performed on the file, the status 513 indicates “STUB PROCESS PERFORMED”.

The stub type 514 indicates the type of the stub file. In FIG. 4, the stub type 514 indicates “FILE” when the stub file is an actual data file, the stub type 514 indicates “META” when the stub file is a metadata file, and the stub type 514 indicates “DIR” when the stub file is a directory.

The stub file management table 510 illustrated in FIG. 4 holds information in table format. The stub file management table 510 according to the present embodiment may hold the information in any type of format. For example, the NAS 10 may include the contents of the stub file management table 510 in the inode information of a directory provided by the file system to hold the information regarding the stub file as the extended file attribute information. The NAS 10 may hold the contents of the stub file management table 510 in a database.

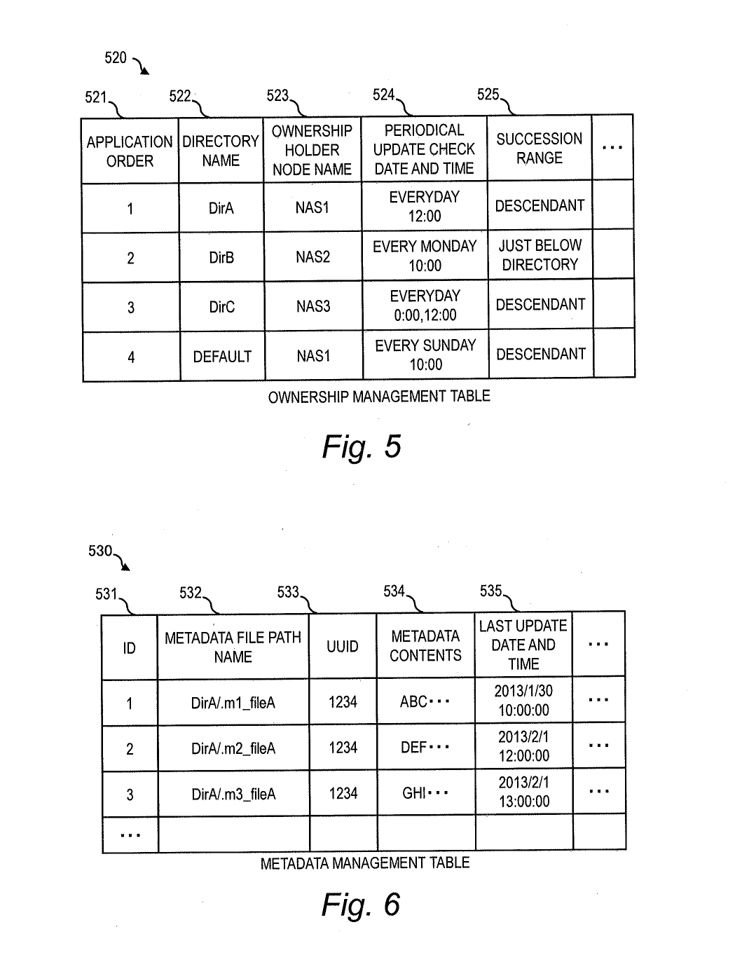

FIG. 5 is an explanatory drawing depicting the ownership management table 520 according to Embodiment 1.

The ownership management table 520 indicates a NAS or the CAS 40 holding the owner ship of a directory provided by the file system of the computer system 1. The ownership management table 520 indicates a trigger for the NAS or the CAS 40 holding the ownership to check the updated content of the configuration information of the directory in the CAS 40.

The ownership management table 520 contains information of an application order 521, a directory name 522, an ownership holder node name 523, a periodical update check date and time 524, and a succession range 525 which are registered in association.

The application order 521 indicates the order in which the entries are applied. For example, the entries are applied in ascending order of numbers in the application order 521 illustrated in FIG. 5. Specifically, when a directory whose configuration information has been updated by an entry A with a smaller number of application order is a directory to be updated by an entry B with a larger number of application order, the configuration information for the case where the entry A is applied is used in preference.

The directory name 522 indicates directory names. In the computer system 1, a directory is shared and the directory name is unique in the computer system 1. Thus, a directory indicated in the directory name 522 can be accessed from any one of the NASs and the CAS 40.

The directory name 522 indicates the full path of a directory in the file system, for example. The directory name 522 illustrated in FIG. 5 may include a special directory name “DEFAULT”. An entry with “DEFAULT” of the directory name 522 is used for assigning an ownership to a directory whose ownership is not defined in the ownership management table 520.

The ownership holder node name 523 indicates the NAS or the CAS 40 with an ownership to update the configuration information of a directory indicated in the directory name 522.

The periodical update check date and time 524 indicates a trigger for the NAS or the CAS 40 holding the ownership to update the configuration information of a directory indicated in the directory name 522. For example, when the NAS or the CAS 40 starts a process to update the configuration information every day at 12:00, the periodical update check date and time 524 illustrated in FIG. 5 indicates “EVERY DAY 12:00”. The periodical update check date and time 524 may indicates a plurality of triggers.

The succession range 525 indicates whether, when a directory indicated by the directory name 522 contains a subdirectory, the NAS or the CAS 40 indicated by the ownership holder node name 523 should succeed the ownership of the subdirectory.

For example, when the NAS or the CAS 40 indicated by the ownership holder node name 523 should succeed the ownerships of all subdirectories and descendant directories of the subdirectories contained in a directory indicated by the directory name 522, the succession range 525 indicates “DESCENDANT”. When the NAS or the CAS 40 indicated by the ownership holder node name 523 hold only the ownership of a directory indicated by the directory name 522, the succession range 525 indicates “JUST BELOW DIRECTORY”.

The ownership management table 520 illustrated in FIG. 5 holds information in table format. The ownership management table 520 according to the present embodiment may hold the information in any type of format. The NAS 10 may hold the contents of the ownership management table 520 in a database.

The ownership management table 520 may be held in the NAS 10 and accessed from other NASs and the CAS 40 when necessary. The ownership management table 520 may be held in each of all the NASs 10 and CAS 40. The ownership management table 520 may be held in a computer different from the NASs 10 and CAS 40.

FIG. 6 is an explanatory drawing depicting the metadata management table 530 according to Embodiment 1.

The metadata management table 530 indicates metadata stored in a object of the CAS 40. The CAS 40 holds the metadata management table 530 for each object storing metadata. The metadata management table 530 contains information of an ID 531, a metadata file path name 532, a UUID 533, a metadata content 534, and a last update date and time 535 which are registered in association.

The ID 531 is used when the object stores pieces of metadata and indicates identifiers of the pieces of metadata in the object. For example, the ID 531 indicates the order the pieces of metadata were stored in the object.

The metadata file path name 532 indicates the path of the metadata file corresponding to metadata and the NAS in which the metadata was created. The metadata management table 530 illustrated in FIG. 6 indicates an example where different pieces of metadata from the NAS 10, the NAS 20 and the NAS 30 are added to one object.

Specifically, when the identifier of the NAS 10 is “1”, the identifier of the NAS 20 is “2”, and the identifier of the NAS 30 is “3”, the metadata file path name 532 indicates “DirA/.m1_fileA” using the above described “.m<NAS identifier>”as the path of the metadata stored in the NAS 10. The metadata file path name 532 indicates “DirA/.m2_fileA” as the path of the metadata stored in the NAS 20. The metadata file path name 532 indicates “DirA/.m3_fileA” as the path of the metadata stored in the NAS 30.

The UUID 533 includes the UUID indicating the object. The metadata management table 530 illustrated in FIG. 6 is held for each object, thus the UUID 533 illustrated in FIG. 6 contains the same values. When the metadata management table 530 indicates metadata of all objects, the UUID 533 indicates the UUIDs in accordance with the objects.

The metadata contents 534 indicates the content of metadata. The content of metadata may be managed in a different storage area from the metadata management table 530. When the content of metadata is managed in the different storage area, the metadata contents 534 may include reference information (path name, URL, ID and the like) necessary for accessing the metadata.

The last update date and time 535 indicates the date and time when an entry of the metadata management table was last updated. Upon receiving a request for deleting an entry of the metadata management table 530, the object management module 421 may delete only data in the metadata contents 534, leave the entry itself and update the last update date and time 535 with the date and time when the metadata was deleted so that the object management module 421 can identify the deleted metadata after deleting the metadata from the CAS 40.

The metadata management table 530 in FIG. 6 holds information in table format. The metadata management table 530 according to the present embodiment may hold the information in any type of format. The CAS 40 may hold the content of the metadata management table 530 in a database.

Next, a processing flow of the computer system 1 will be described. Hereinafter, a file registration process, a file backup process, a file recall process, a file restoration process and a directory configuration information update process will be described.

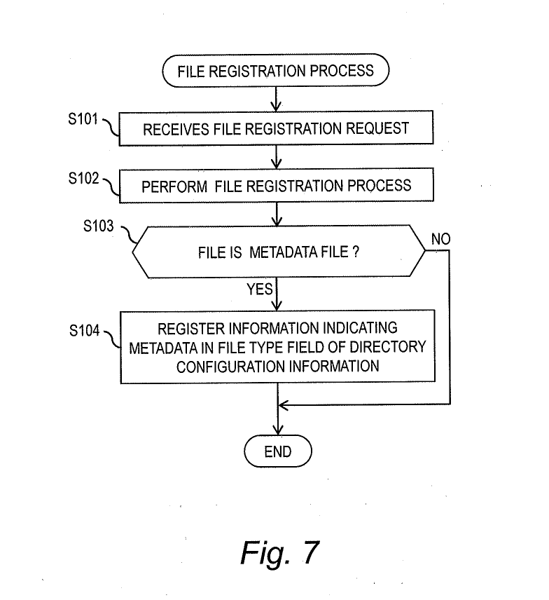

FIG. 7 is a flowchart depicting the file registration process according to Embodiment 1.

At the start time of the process in FIG. 7, a user sends a file registration request to the NAS 10 for registering a file from the client machine in the NAS 10. The file registration request contains actual data or metadata, a file name to be registered and a path name.

In the process illustrated in FIG. 7, the client machine 50 and the NAS 10 store actual data or metadata requested to be stored as an actual data file or a metadata file in the NAS 10 via a file interface provided by the file management module 121.

The file management module 121 receives a file registration request (S101). After S101, the file management module 121 registers data contained in the file registration request in the auxiliary storage 14 by a file registration process provided by the file system (S102). Thereby, an actual data file or a metadata file is created in the NAS 10.

In S102, the file management module 121 registers the requested file in the directory configuration table 500 corresponding to the designated path in the registration request. Specifically, the file management module 121 stores the file name designated in the registration request in the entry name 501 of a new entry in the directory configuration table 500 and update the last update date and time 504 of the new entry with the current date and time.

In S102, the file management module 121 creates a new stub file management table 510 corresponding to the file designated in the registration request. The file management module 121 stores an identifier indicating the stub process is not performed in the status 513 of the new stub file management table 510.

After S102, the metadata management module 123 determines whether the file registered by the file registration process is a metadata file. The metadata management module 123 refers to the file name designated by the file registration request and determines that the registered file is a metadata file when the designated file name is an identifier created in advance by a predetermined method as a metadata file name.

For example, as explained previously, when “.m” is added to the prefix of the designated identifier, the metadata management module 123 determines that the designated file in the registration request is a metadata file.

If the registered file is a metadata file (S103: Yes), the metadata management module 123 stores the identifiers indicating metadata in the file type 503 of a new entry of the directory configuration table 500 and in the stub type 514 of a new stub file management table 510 (S104). The metadata file is stored in the same directory as the actual data file in the present embodiment.

If the registered file is not a metadata file (S103: No), the metadata management module 123 stores the identifiers indicating actual data in the file type 503 of a new entry of the directory configuration table 500 and in the stub type 514 of a new stub file management table 510 and ends the process illustrated in FIG. 7.

A method to determine whether the registered file is a metadata file may be any method other than the example described above. For example, when an identifier indicating a metadata file is added to the suffix of the designated file name, the metadata management module 123 may determine that the registered file is a metadata file. When the NAS 10 is equipped with a dedicated file system for metadata files and a metadata file is written by the dedicated file system, the metadata management module 123 may determine that the registered file is a metadata file.

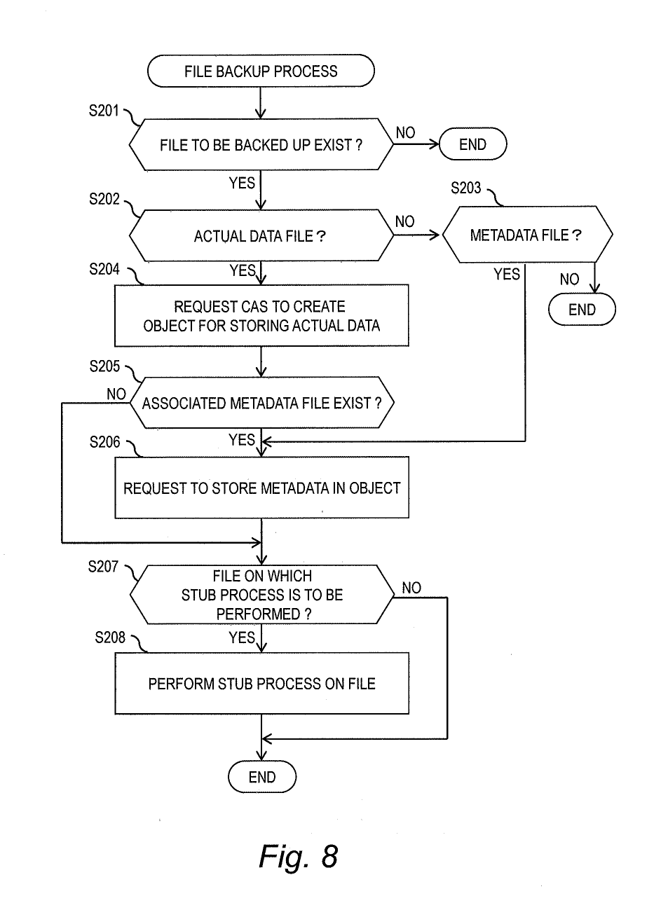

FIG. 8 is a flowchart depicting a file backup process according to Embodiment 1.

The process illustrated in FIG. 8 transfers a file stored in the NAS 10 to the CAS 40 and performs the stub process on the transferred file in the NAS 10. The process illustrated in FIG. 8 allows the storage capacity of the NAS 10 to be utilized efficiently. Upon receiving an access request, the NAS performs a file recall process described later so that the computer system 1 according to Embodiment 1 can maintain the accessibility to the file.

A file to be baked up to the CAS 40 is selected by a predetermined method. For example, the file management module 121 may select a file which has passed a specific time since the last update date and time as a file to be backed up. The file management module 121 may select all files stored in the NAS 10 as file to be backed up when they are stored.

The hierarchical storage control module 124 determines whether the auxiliary storage 14 holds a file selected in advance as a file to be backed up. If no file to be backed up is held in the auxiliary storage 14 (S201: No), the hierarchical storage control module 124 ends the process illustrated in FIG. 8.

If one or more files to be backed up are held in the auxiliary storage 14 (S201: Yes), the hierarchical storage control module 124 selects one file to be backed up and proceeds to S202. The selected file is described as the file A in the following explanation of the process in FIG. 8.

In S202, the hierarchical storage control module 124 determines whether the file A is an actual data file based on the file type 503 of the directory configuration table 500. If the file A is an actual data file (S202: Yes), the hierarchical storage control module 124 performs S204. If the file A is not an actual data file (S202: No), the hierarchical storage control module 124 performs S203.

In S203, the hierarchical storage control module 124 determines whether the file A is a metadata file (metadata file A1 hereinafter) based on the file type 503 of the directory configuration table 500. If the file A is a metadata file A1 (S203: Yes), the hierarchical storage control module 124 performs S206. If the file A is not a metadata file A1 (S203: No), the hierarchical storage control module 124 ends the process illustrated in FIG. 8 and performs the process illustrated in FIG. 8 on another file to be backed up.

In S204, the hierarchical storage control module 124 sends the file name of the file A and the directory name (file path name) in which the file A will be stored to the CAS 40. The hierarchical storage control module 124 requests the object management module 421 of the CAS 40 to create an object (object A hereinafter) to store the actual data corresponding to the file A. The hierarchical storage control module 124 sends the actual data corresponding to the file A to the CAS 40 and instructs the object management module 421 to store the actual data in the newly created object A.

Upon receiving the request to create the object A, the object management module 421 creates the object A and assigns an UUID to, the created object A. The object management module 421 holds the file path name of the file A associated with the created object. The object management module 421 notifies the NAS 10 of the UUID assigned to the object A.

Upon receiving the notification of the UUID from the object management module 421, the hierarchical storage control module 124 stores the notified UUID in the UUID 502 of the directory configuration table 500 of the directory which stores the file A. The hierarchical storage control module 124 stores the received UUID in the UUID 512 of the stub file management table 510 of the file A.

S204 may use any method for storing the actual data corresponding to the file A in the object A. Specifically, when the UUID 502 of the directory configuration table 500 already holds the UUID of the file A and the CAS 40 already holds the object A, the object management module 421 updates the held actual data of the object A with the actual data sent from the NAS 10.

In S204, when the UUID 502 does not hold the UUID of the file A and the UUID 502 of the metadata file associated with the file A holds the UUID, the object management module 421 stores the actual data of the file A in the object indicated by the UUID 502 of the metadata file associated with the file A. The object management module 421 stores the value of the UUID 502 of the metadata file associated with the file A in the UUID 502 and UUID 512 of the file A.

After S204, the metadata management module 123 determines whether the metadata file (metadata file A2 hereinafter) associated with the file A exists (S205). Specifically, the metadata management module 123 refers to the entry name 501 of the directory configuration table 500, and when the directory configuration table 500 shows the metadata file A2, the metadata management module 123 determines that the metadata file A2 exists.

If the metadata file A2 exists (S205: Yes), the hierarchical storage control module 124 performs S206. If the metadata file A2 does not exist (S205: No), the hierarchical storage control module 124 performs S207.

Hereinafter, the metadata file A is the generic term for the metadata file A1 and the metadata file A2. The metadata file A2 corresponds to metadata backed up along with actual data by the CAS 40. The metadata file A1 corresponds to metadata backed up solely.

In S206, the hierarchical storage control module 124 requests the object management module 421 to store the metadata of the metadata file A in the object indicated by the directory configuration table 500.

Specifically, in S206, the hierarchical storage control module 124 refers to the directory configuration table 500 of the directory which stores the metadata file A and acquires the UUID of the metadata file A. When the UUID of the metadata file A is not stored in the UUID 502 of the directory configuration table 500 indicating the metadata file A, the hierarchical storage control module 124 acquires the UUID of the actual data file associated with the metadata file A as the UUID of the metadata file A. The hierarchical storage control module 124 stores the acquired UUID in the UUID 502 and the UUID 512 of the metadata file A.

When the UUID is also not assigned to the actual data file associated with the metadata file A, the hierarchical storage control module 124 may transmit the file name of the metadata file A and the directory name of the directory which stores the metadata file A to the CAS 40, and request the CAS 40 to create an object to store the metadata of the metadata file A.

When the object management module 421 creates the object to store the metadata in accordance with the request, the object management module 421 adds an entry to the metadata management table 530. The path name 532 of the entry stores the transmitted file name of the metadata file A and the transmitted directory name of the directory which stores the metadata file A.

The hierarchical storage control module 124 may acquire the UUID of the newly created object from the CAS 40. The hierarchical storage control module 124 may stores the acquired UUID in the UUID 502 and the UUID 512 of the metadata file A.

In S206, the hierarchical storage control module 124 transmits the acquired UUID, the metadata of the metadata file and the metadata file name of the metadata file A to the CAS 40. The object management module 421 stores the metadata received from the NAS 10 in the object indicated by the UUID received from the NAS 10. The object management module 421 stores an entry indicating the added metadata in the metadata management table 530.

When the metadata of the received metadata file name is already stored in the object indicated by the UUID received from the NAS 10, the hierarchical storage control module 124 updates the metadata of the received metadata file name in the object indicated by the received UUID with the received metadata. The object management module 421 updates the entry (the metadata contents 534 and the last update date and time 535) indicating the metadata of the NAS 10 in the metadata management table 530.

When the metadata of the NAS 10 is not stored in the object indicated by the received UUID before starting S206, the object management module 421 stores information regarding the metadata of the metadata file A in a new entry of the metadata management table 530.

After S206, the hierarchical storage control module 124 determines whether the file A is a file on which the stub process is to be performed (S207). If the file A is a file on which the stub process is to be performed (S207: Yes), the hierarchical storage control module 124 performs S208. If the file A is not a file on which the stub process is to be performed, the hierarchical storage control module 124 ends the process illustrated in FIG. 8.

Before the hierarchical storage control module 124 starts the process illustrated in FIG. 8, files on which the stub process is to be performed are designated by a user like an administrator. Thus, in S207, the hierarchical storage control module 124 determines whether the file A is a file on which the stub process is to be performed in accordance with the designation by the user.

In S208, the hierarchical storage control module 124 performs the stub process on the file A. Specifically, the hierarchical storage control module 124 deletes the data of the file A and then updates the status 513 of the file A of the stub management table 510 to the identifier indicating the stub process has been performed. The hierarchical storage control module 124, for example, enters the information stored in the stub file management table 510 of the file A into the file A.

When S208 is not performed, the process illustrated in FIG. 8 merely replicates the file A from the NAS 10 to the CAS 40. Thus, a user may specify whether to perform the stub process on the file A by S208 to reduce the storage capacity of the NAS 10 in accordance with the management policy of the computer system 1 or the NAS.

The NAS and the CAS 40 use the UUID to identify an object in the process illustrated in FIG. 8. Alternatively, since combination of an object and actual data is unique, an actual data file name may be used to identify an object.

In S202 and S206, when the hierarchical storage control module 124 transmits the actual data or the metadata to the CAS 40, the hierarchical storage control module 124 transmits the attribute information of the file A or the metadata file A. The object management module 421 stores the attribute information in the object or holds the attribute information in association with the object.

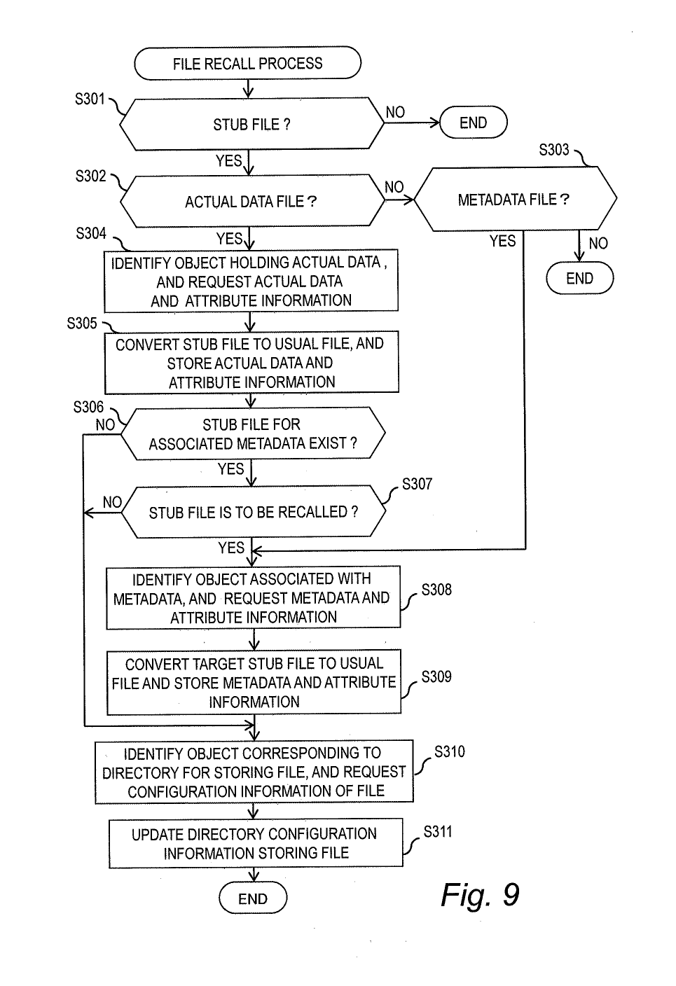

FIG. 9 is a flowchart depicting a file recall process according to Embodiment 1.

In the process illustrated in FIG. 9, upon receiving an access request for referring to a stub file, the NAS 10 acquires the data of the stub file from the CAS 40, converts the stub file to a usual file and provides the access requester with the data of the requested file.

The hierarchical storage control module 124 determines whether a file (file B hereinafter) designated in an access request is a stub file based on the stub type 514 of the stub file management table 510 (S301). If the file B is not a stub file (S301: No), the file recall process is unnecessary and the hierarchical storage control module 124 ends the process illustrated in FIG. 9. If the file B is a stub file (S301: Yes), the hierarchical storage control module 124 performs S302.

In S302, the hierarchical storage control module 124 determines whether the file B is an actual data file based on the file type 503 of the directory configuration table 500. If the file B is an actual data file (S302: Yes), the hierarchical storage control module 124 performs S304. If the file B is not an actual data file (S302: No), the hierarchical storage control module 124 performs S303.

In S303, the hierarchical storage control module 124 determines whether the file B is a metadata file based on the file type 503 of the directory configuration table 500. If the file B is a metadata file (S303: Yes), the hierarchical storage control module 124 performs S308. If the file B is not a metadata file (S303: No), the hierarchical storage control module 124 ends the process illustrated in FIG. 9.

In S304, the hierarchical storage control module 124 identifies the object of the CAS 40 associated with the file B and acquires the actual data and the attribute information of the file B from the CAS 40. Specifically, the hierarchical storage control module 124 transmits the UUID (corresponding to the UUID 502 of the directory configuration table 500) acquired in the backup of the file B or the file name of the file B to the CAS 40 and causes the CAS 40 to identify the object associated with the file B.

Upon receiving a UUID from the NAS 10, the object management module 421 of the CAS 40 transmits the actual data stored in the object indicated by the UUID and the attribute information of the actual data to the NAS 10. Upon receiving a file path name from the NAS 10, the object management module 421 identifies the object storing the actual data indicated by the file path name and transmits the actual data of the identified object and the attribute information of the actual data to the NAS 10.

After S304, the hierarchical storage control module 124 converts the file from a stub file to a usual file. Specifically, the hierarchical storage control module 124 updates the status 513 of the entry indicating the file B in the stub file management table 510 to the value indicating usual file.

The hierarchical storage control module 124 stores the actual data acquired from the CAS 40 in the auxiliary storage 14 and stores the attribute information acquired from the CAS 40 in the stub file management table 510. The hierarchical storage control module 124 updates the file B such that the file B points to the actual data stored in the auxiliary storage 14.

The hierarchical storage control module 124 determines whether a metadata file associated with the file B exists and the metadata file is a stub file (S306). The hierarchical storage control module 124 determines that the metadata file associated with the file B exists when a metadata file the UUID 502 of which in the directory configuration table 500 coincides with the UUID of the file B.

In S306, the hierarchical storage control module 124 estimates the metadata file name based on the filename of the file B. When the directory configuration table 500 indicates the estimated metadata file name, the hierarchical storage control module 124 may determine that the metadata file associated with the file B exists.

In S306, the hierarchical storage control module 124 refers to the status 513 of the stub file management table 510. When the status 513 of the metadata file associated with the file B indicates that the stub process has been performed, the hierarchical storage control module 124 determines that the metadata file associated with the file B is a stub file.

If a metadata file associated with the file B exists and the metadata file is a stub file (S306: Yes), the hierarchical storage control module 124 performs S307. If a metadata file associated with the file B does not exist or the metadata file is not a stub file (S306: No), the hierarchical storage control module 124 performs S310.

In S307, the hierarchical storage control module 124 determines whether to recall the metadata of the metadata file associated with the file B. For example, when applied is a policy of the computer system 1 to perform the file recall process on an actual data file and then the file recall process on the metadata file associated with the actual data file, the hierarchical storage control module 124 may determines to recall the metadata. The hierarchical storage control module 124 may be configured to recall the metadata of the metadata file associated with the file B without any condition.

If the metadata (metadata B hereinafter) of the metadata file associated with the file B is recalled (S307: Yes), the hierarchical storage control module 124 performs S308. If the metadata B is not recalled (S307: No), the hierarchical storage control module 124 performs S310.

In S308, the hierarchical storage control module 124 identifies the object of the CAS 40 to store the metadata B. The hierarchical storage control module 124 acquires the metadata B to be stored in the identified object and the attribute information of the metadata B from the CAS 40. The way how to identify the object is the same as S304.

After S308, the hierarchical storage control module 124 convers the metadata file associated with the file B from a stub file to a usual file.

Specifically, the hierarchical storage control module 124 stores the acquired metadata in the auxiliary storage 14 and stores the acquired attribute information in the stub file management table 510. The hierarchical storage control module 124 updates the metadata file such that the metadata file points to the metadata stored in the auxiliary storage 14 (S309).

After S309, the hierarchical storage control module 124 performs S310.

In S310, the hierarchical storage control module 124 identifies the directory (directory B hereinafter) which stores the file B and the object of the CAS 40 corresponding to the directory B. The hierarchical storage control module 124 requests the configuration information of the object of the directory B from the CAS 40.

Specifically, the hierarchical storage control module 124 extracts the UUID in the UUID 502 of the entry the entry name 501 of which indicates the directory for storing the file B, from the directory configuration table 500 indicating the file B. The hierarchical storage control module 124 includes the extracted UUID in the request for the configuration information of the directory B and transmits the request to the CAS 40.

Upon receiving the request for the configuration information of the directory B from the NAS 10, the object management module 421 acquires data from the actual data storage area 75 of the object indicated by the UUID contained in the request and transmits the acquired data to the NAS 10 as the configuration information. The data acquired from the actual data storage area 75 is the configuration information of the directory B.

After S310, the hierarchical storage control module 124 updates the directory configuration table 500 the entry name 501 of which indicates the file B with the configuration information of the directory B acquired from the CAS 40 (S311). Namely, in S311, the hierarchical storage control module 124 updates the contents of the directory configuration table 500 of the directory B in the file system of the NAS 10 with the configuration information of the directory B held in the CAS 40.

Thereby, for example, the metadata M2 created by the NAS 20 is associated with the actual data (file) stored in the directory B and when the metadata M2 is stored in the object of the actual data, the hierarchical storage control module 124 can acquire the configuration information of the directory B indicating the metadata M2. The update of the directory configuration table 500 of the NAS 10 allows the hierarchical storage control module 124 to perform the recall process (FIG. 9) on the metadata M2.

In other words, it allows the NAS 10 to share metadata created in another NAS that the NAS 10 updates the directory configuration table 500 with the configuration information of the directory acquired from the CAS 40.

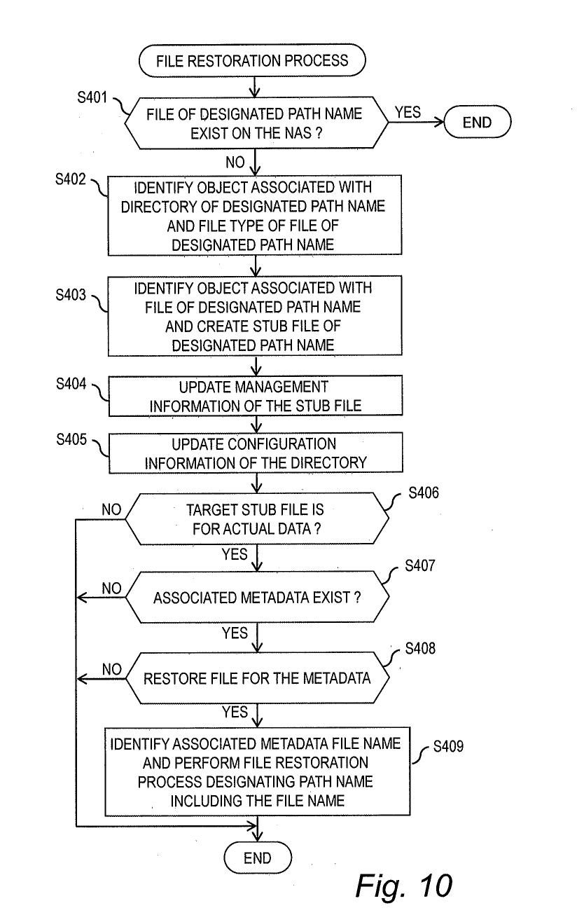

FIG. 10 is a flowchart depicting the file restoration process according to Embodiment 1.

The process illustrated in FIG. 10 is the file restoration process which is performed when the NAS 10 receives an access request designating a file path name and the NAS 10 does not holds the designated file (usual file or stub file). The file restoration process includes a process for acquiring the file data of the designated file path name from the CAS 40 and a process for creating a stub file in the NAS 10.

After the stub file is created in the process illustrated in FIG. 10, the file recall process illustrated in FIG. 9 is performed as necessary for a user to refer to the file.

The file path name designated at the start of the file restoration process indicates the file name and the directory name of the directory which stores the file.

The hierarchical storage control module 124 determines whether the NAS 10 holds the file the path name of which is designated in the access request (S401). If it is held (S401: Yes), the restoration is not necessary and the hierarchical storage control module 124 ends the process illustrated in FIG. 10. If it is not held (S401: No), the hierarchical storage control module 124 performs S402.

When the auxiliary storage 14 does not hold the parent directory of the directory which stores the designated file, this directory also needs to be restored. In this case, the hierarchical storage control module 124 acquires the configuration information of the parent directory of the directory for storing the designated file from the CAS 40. The hierarchical storage control module 124 restores the parent directory by performing the process illustrated in FIG. 10 using the acquired configuration information of the parent directory.

Restoration of a parent directory may be restoration of the root directory. The directory configuration table 500 according to the present embodiment contains the UUID associated with the root directory.

Hereinafter, the process in the case where the auxiliary storage 14 stores the parent directory of the directory for storing each designated file.

In S402, the hierarchical storage control module 124 acquires the file type of the designated file from the CAS 40 by causing the CAS 40 to identify the object of the directory for storing the designated file (corresponding to the object 73 in FIG. 1). Specifically, the hierarchical storage control module 124 transmits the designated file path name or the UUID (corresponding to the UUID 502 of the directory configuration table 500) of the directory to store the designated file to the CAS 40.

In S402, when the object management module 421 of the CAS 40 receives a file path name or UUID, the object management module 421 identifies the object of the directory for storing the designated file based on the received file path name or UUID. The object management module 421 determines the file type of the designated file from the identified object. The object management module 421 notifies the NAS 10 of the determined file type.

After S402, the hierarchical storage control module 124 causes the CAS 40 to identify the object associated with the designated file (corresponding to the object 74 in FIG. 10), and acquires the attribute information of the designated file from the identified object. The hierarchical storage control module 124 creates a stub file for the designated file (S403).

Specifically, the hierarchical storage control module 124 transmits the designated file path name or the UUID of the designated file to the CAS 40 in S403. The object management module 421 of the CAS 40 identifies the object storing the data of the received file path name or the object of the received UUID, and acquires the attribute information of the data of the received file path name from the identified object. The object management module 421 transmits the acquired attribute information to the NAS 10.

After S403, when the designated file is not registered in the stub file management table 510 as a stub file, the hierarchical storage control module 124 registers the designated file in the stub file management table 510 as a stub file (S404). Specifically, the hierarchical storage control module 124 updates the stub type 514 with the file type acquired from the CAS 40 in the stub file management table 510 of the designated file, stores the attribute information acquired from the CAS 40 and updates the status 513 to the value indicating that the stub process has been performed.

When the stub file management table 510 indicating the designated file is not held at the start of S403, the hierarchical storage control module 124 creates a new stub file management table 510 indicating the designated file.

After S404, when the directory configuration table 500 does not contain the information regarding the designated file, the hierarchical storage control module 124 updates the directory configuration table 500 base on the file type acquired in S402 and the attribute information acquired in S403 (S405).

After S405, the hierarchical storage control module 124 determines whether the designated file is an actual data file (S406). Specifically, when the stub type 514 updated in S404 indicates actual data file, the hierarchical storage control module 124 determines that the designated file is an actual data file. If the designated file is an actual data file (S406: Yes), the hierarchical storage control module 124 performs S407. If the designated file is not an actual data file (S406: No), the process in FIG. 10 ends.

In S407, the hierarchical storage control module 124 determines whether a metadata file associated with the designated file exists. The hierarchical storage control module 124 refers to the directory configuration table 500 of the directory for storing the designated file, and when the directory configuration table 500 indicates a file the value of UUID 502 of which indicates the same file as the designated file, in other words, indicates the associated file, the hierarchical storage control module 124 determines that the metadata file exists. If the metadata file exists (S407: Yes), the hierarchical storage control module 124 performs S408. If the metadata file does not exist (S407: No), the process in FIG. 10 ends.

In S408, the hierarchical storage control module 124 determines whether to restore the metadata file determined to exist in S407. For example, when the policy applied to of the computer system 1 indicates to perform the restoration process on the associated metadata file after the file restoration process on the actual data file, the hierarchical storage control module 124 determines to perform the file restoration process on the metadata file.

The hierarchical storage control module 124 may determine to perform the file restoration process on the associated metadata file unconditionally when the file restoration process is performed on the designated file. If the file restoration process is performed on the metadata file (S408: Yes), the hierarchical storage control module 124 performs S409. If the file restoration process is not performed on the metadata file (S408: No), the process in FIG. 10 ends.

In S409, the hierarchical storage control module 124 identifies the file path name of the metadata file associated with the designated file based on the directory configuration table 500 and performs the file restoration process from S401 recursively.

The file restoration process illustrated in FIG. 10 allows creating a stub file of an actual data file and a metadata file.

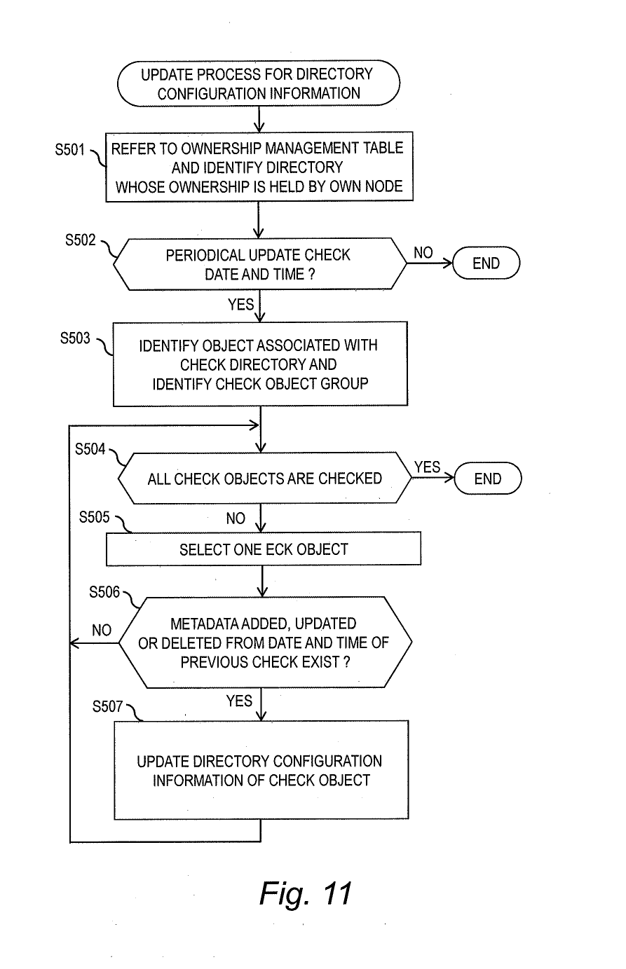

FIG. 11 is a flowchart of a process for updating the directory configuration information held in an object according to Embodiment 1.

The process illustrated in FIG. 11 updates the directory configuration information of a directory provided by the file sharing service of the computer system 1. This process and the process illustrated in FIG. 9 allow information of metadata added to or updated in an object in the CAS 40 from each NAS of the computer system 1 to be shared by all of NASs of the computer system 1. Each of the NASs and CAS 40 according to the present embodiment is allocated the ownership to update the directory configuration information. The directory configuration information is updates for individual directories.

Immediately after metadata is added to or updated in a NAS and the process illustrated in FIG. 8 stores the added or updated metadata in the CAS 40, the directory information of the object 73 is not updated with the information regarding the added or updated metadata. Thus, immediately after the metadata is stored in the CAS 40, NASs other than the NAS which has added or updated the metadata are not capable of file-recalling the added or updated metadata from the CAS 40.

However, the process illustrated in FIG. 11 updates the directory configuration information of the object 73 with the latest state of the object 74 and the process illustrated in FIG. 9 updates the directory configuration table 500 of each NAS with the directory configuration information of the CAS 40, thereby, all the NASs are capable of to file-recalling all metadata. Further, all the NASs are capable of sharing all metadata.

In an example described below, the NAS 10 performs the process illustrated in FIG. 11. All the NASs and the CAS 40 perform the process illustrated in FIG. 11.

The metadata management module 123 of the NAS 10 refers to the ownership management table 520 every predefined period of time or in response to an indication from a user, and identifies directories whose directory configuration information is updated by the NAS 10 from the directory name 522 of entries the ownership holder node name 523 of which indicates the NAS 10 (S501).

In S501, the metadata management module 123 omits the overlap between directories indicated by entries the ownership holder node name 523 of which indicate the NAS 10 and directories indicated by other entries, and identifies the directories the directory configuration information of which is to be updated.

Specifically, the metadata management module 123 omits directories whose ownerships are held by NASs other than the NAS 10 and the ranks of the application order 521 are higher than the NAS 10 from descendant directories of the directories whose ownerships are held by the NAS 10 in the directories indicated in the directory name 522. The metadata management module 123 identifies the left directories after the omission as directories whose ownerships are held by the NAS 10.

After S501, the metadata management module 123 refers to the periodical update check date and time 524 the current time and determines whether an entry whose value of the periodical update check date and time 524 corresponds to the current time exists in the entries indicating the identified directories. If an entry whose value of the periodical update check date and time 524 corresponds to the current time exists (S502: Yes), the metadata management module 123 performs S503. If no entry whose value of the periodical update check date and time 524 corresponds to the current time exists (S502: No), the metadata management module 123 determines that it is not time to perform the process illustrated in FIG. 11 and end the process illustrated in FIG.

Hereinafter, an entry whose value of the periodical update check date and time 524 corresponds to the current time in the identified directories in S501 is described as an entry C. The directory indicated by the entry C is described as a check directory.

In S503, the metadata management module 123 causes the CAS 40 to identify the object associated with the check directory, and identifies the object (check object group) the directory configuration information of which is to be updated. The method for identifying the object associated with the check directory causes the object management module 421 to identify the object with the directory name or the UUID like S304 in FIG. 9 described above.

When the metadata management module 123 identifies the objects of the check directories or descendant directories of the check directory in S503, the metadata management module 123 repeats the method to identify the associated object.

In S504, the metadata management module 123 determines whether the need for update for each of all the check objects in the check object group is checked by the process of S506. If the process of S506 is performed on all the check objects (S504: Yes), the metadata management module 123 ends the process illustrated in FIG. 11. If the check object group contains a check object on which the process of S506 is not performed yet (S504: No), the metadata management module 123 performs S505.

In S505, the metadata management module 123 selects a check object (check directory) on which the process of S506 is not performed yet from the check object group.

After S505, the metadata management module 123 determines whether the check directory of the selected check object includes metadata added, updated or deleted from the date and time of previous performance of S506 to the current time (S506).

Specifically, the metadata management module 123 causes the object management module 421 to extract, from the metadata management table 530, an entry the path name 532 of which contains the directory name of the selected check directory and the last update day and time 535 of which indicates a time point from the day and time of previous performance of S506 to the current time. If the entry is extracted, the metadata management module 123 determines that the check directory includes metadata added, updated or deleted.

If the check directory includes metadata added, updated or deleted (S506: Yes), the metadata management module 123 performs S507. If the check directory does not include metadata added, updated or deleted (S506: No), the metadata management module 123 performs S504.

In S507, the metadata management module 123 instructs the object management module 421 to update the directory configuration information held by the selected check object based on the metadata added, updated or deleted and the object in which the metadata is stored (S507).

Specifically, the object management module 421 identifies at least one entry of the metadata management table 530 indicating the metadata added, updated or deleted in accordance with the instruction from the metadata management module 123. The object management module 421 extracts the path name 532, the UUID 533 and the last update date and time 535 of the identified entry as the information of metadata added, updated or deleted, and updates the directory configuration information of the selected check object stored in the actual data storage area with the extracted information of metadata.

In accordance with the instruction from the metadata management module 123, the object management module 421 acquires, as the information of the object (object 74 in FIG. 1) in which the metadata added, updated or deleted is stored, the actual data file name of the actual data stored in the object and the UUID of the object. The object management module 421 updates the directory configuration information of the selected check object with the acquired information of the object.

Thereby, when the actual data associated with the metadata is added to the object, the object management module 421 is capable of storing the information regarding the added actual data in the directory configuration information of the check object.

After S507, the metadata management module 123 performs S504.

When the number of NASs included in the computer system 1 according to the present embodiment is small, after the process illustrated in FIG. 11, the directory configuration tables 500 of all the NASs may be updated based on the directory configuration information held by the object 73. When the number of NASs is large, updating the directory configuration table 500 in S311 in FIG. 9 allows elimination of unnecessary transmission of information.

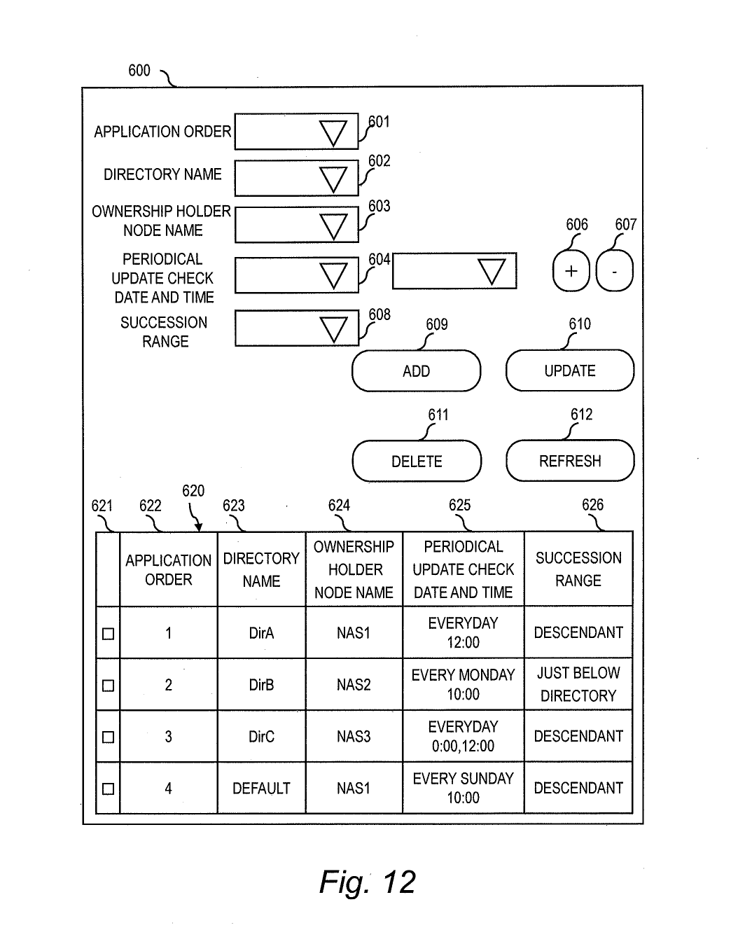

FIG. 12 is an explanatory drawing depicting a setting window 600 according to Embodiment 1.

The setting window 600 is a window for referring to the ownership of directories and setting the ownership. The setting window 600 is displayed on a display device of the client machine by a display module (not shown).

A user, for example a system administrator, sets the ownership of a directory in the ownership management table 520 via the setting window 600. The directory the ownership of which is set is a directory by the file sharing service provided by the computer system 1.

The setting window 600 contains an application order 601, a directory name 602, an ownership holder node name 603, a periodical update check date and time 604, a succession range 608, a plus button 606, a minus button 607, an add button 609, an update button 610, a delete button 611 and a refresh button 612.

The setting window 600 contains an ownership display field 620 for displaying the same contents as the ownership management table 520. A application order 622, a directory name 623, an ownership holder node name 624, a periodical update check date and time 625, and a succession range 626 are the same as the application order 521, the directory name 522, the ownership holder node name 523, the periodical update check date and time 524, and the succession range 525, respectively.

The ownership display field 620 contains a check field 621. The check field 621 is used for a user to select a plurality of items simultaneously. When a user selects a plurality of boxes in the check field 621 and presses down the delete button 611, the display module deletes a plurality of entries selected in the ownership display field 620. Entries corresponding to the selected entries are deleted from all the ownership management tables 520.

When a user inputs information to the application order 601, the directory name 602, the ownership holder node name 603, the periodical update check date and time 604 and the succession range 608, and presses down the add button 609, the display module displays the input information as a new entry of the ownership display field 620. An entry corresponding to the new entry of the ownership display field 620 is added to each ownership management table 520.

When a user selects a box in the check field 621, the display module outputs the contents of the entry selected in the check field 621 to the application order 601, the directory name 602, the ownership holder node name 603, the periodical update check date and time 604 and the succession range 608. The display module allows the user to modify the outputted information as necessary.

When the user presses down the update button 610 after the modification, the display module updates the ownership display field 620 with the modified contents. All the ownership management tables 520 are updated in accordance with the update of the ownership display field 620.

The periodical update check date and time 604 may contains a region for inputting the date for performing the process illustrated in FIG. 11 and region for inputting the time for performing the process illustrated in FIG. 11. The display module may show the plus button 606 or the minus button 607 for a user to add a term to be inputted to or delete the added term from the periodical update check date and time 604.

When a user presses down the refresh button 612, the display module acquires the information of the ownership management table 520 and outputs the latest information to the ownership display field 620.

The setting window 600 illustrated in FIG. 12 is a GUI image. Alternatively, the computer system 1 according to Embodiment 1 may cause a user to set the ownership management table 520 in any other display method or input method. For example, the client machine 50 or the NAS may output a CLI or an API by a method for program or a command for acquiring and setting the information of the ownership management table 520

As described above, the computer system according to the present embodiment allows the NAS 10 providing the file sharing service via the file interface to provide actual data and metadata associated with each other via the file interface and transmit data to the CAS 40 while maintaining the association between the actual data and metadata. It is possible to acquire the actual data and the metadata from the NAS 20 and the NAS 30 while maintaining the association. Further, it is possible for a plurality of NASs to add or update their own metadata concurrently for actual data.

This allows actual data to be shared by a plurality of NASs and allows a plurality pieces of metadata created by a plurality NASs to be stored in the CAS 40 in parallel. The CAS 40 holding actual data and metadata associated with each other allows a plurality NASs to share a plurality pieces of metadata. It allows a plurality pieces of metadata created in different viewpoints or methods to be shared by a plurality of NASs and each NAS to search for or analyze the actual data with ease.

### Embodiment 2

The process described in Embodiment 1 is performed after data is stored in the NAS, and provides a function for referring to the actual data and the associated metadata.

There are cases where data to be stored in the NAS or the CAS 40 is not created in the computer system 1 and the data is acquired from a data source other than the NAS or the CAS 40.

Particularly, when data is transferred from a data source storing a large amount of data to the computer system 1, there is a case where the time to transfer the data is long. In this case, a user is prohibited to refer to actual data and metadata until the data transfer is completed, resulting in concerns that convenience for users is decreased.

A computer system 4 according to Embodiment 2 includes a data source and transfer data from the data source to the computer system 1. In the present embodiment, the data transfer is described as ingestion. The computer system 4 according to Embodiment 2 causes the client machine 50 to refer to the actual data and further, refer to metadata associated with the actual data using the file interface.

Embodiment 2 is different from Embodiment 1 in that the computer system 4 according to Embodiment 2 includes a control module for causing data to be referred during ingestion, performs cache control for allowing data to be referred with high speed during ingestion, and sets a method for locating the storage location of the metadata from the actual data file.

Further, Embodiment 2 is different from Embodiment 1 in that the computer system 4 according to Embodiment 2 performs an ingestion process, an access process for referring to actual data to be ingested, and an access process for referring to metadata to be ingested.

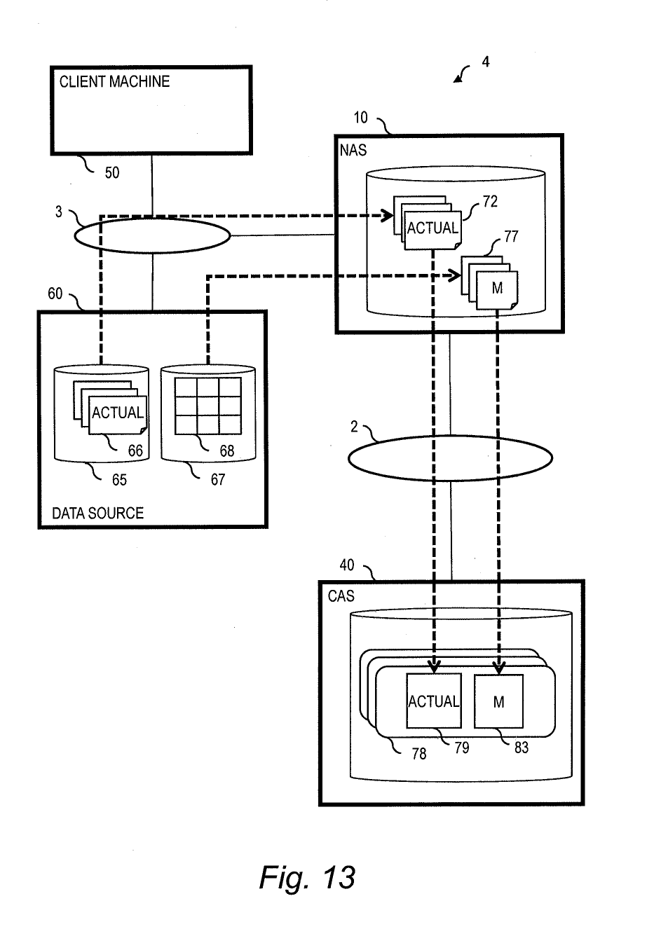

FIG. 13 is an explanatory drawing depicting the outline of the process performed by the computer system 4 according to Embodiment 2.

The computer system 4 according to Embodiment 2 includes the computer system 1 according to Embodiment 1 and a data source 60. The data source 60 is connected with the network 3 and connected with the NASs via the network 3. The data source 60 illustrated in FIG. 13 is connected with the NAS 10, as an example and the data source 60 may be connected with any NAS.

The data source 60 consists of at least one computer and includes at least one processor, a file system 65 and a database 67.

The data source 60 holds actual data to be ingested as a file 66 by the file system 65. The data source 60 holds the metadata associated with the actual data and to be ingested as a table 68 or record in the database 67.

The data source 60 according to Embodiment 2 may hold actual data and metadata by any other configuration instead of the configuration illustrated in FIG. 13.

The NAS 10 holds the actual data ingested from the data source 60 as the file 72 which is an actual data file by the file system. The NAS 10 holds the metadata ingested from the data source 60 as the metadata file 77 by the file system.

After the actual data and the metadata are ingested to the NAS 10, the NAS 10 performs the file backup process illustrated in FIG. 8 and the file recall process illustrated in FIG. 9 and so on as the NAS 10 does in Embodiment 1. Thus, all the NAS in the computer system 1 can share the actual data and the metadata.

The CAS 40 stores the actual data and the metadata received by the file backup in the actual data storage area 79 and the metadata storage area 83 of the object 78 the CAS 40 holds, respectively.

The NAS 10 causes the client machine 50 to refer to the actual data and the metadata being ingested during the ingestion. Thus, in Embodiment 2, the NAS 10 is requested for reference to data before ingestion, data being ingested and ingested data. In the present embodiment, the generic term for data before ingestion, data being ingested and ingested data is ingestion data.

The computer system 4 according to Embodiment 2 holds in advance a method for locating the storage location of the metadata from an actual data file for an access request for referring to data before ingestion. The computer system 4 uses the method to acquire the required data from the data source 60.

Further, the computer system 4 caches a part of ingested data in the NAS for access requests for referring to the data being ingested and the ingested data, resulting in reduction of the response time to the access request.

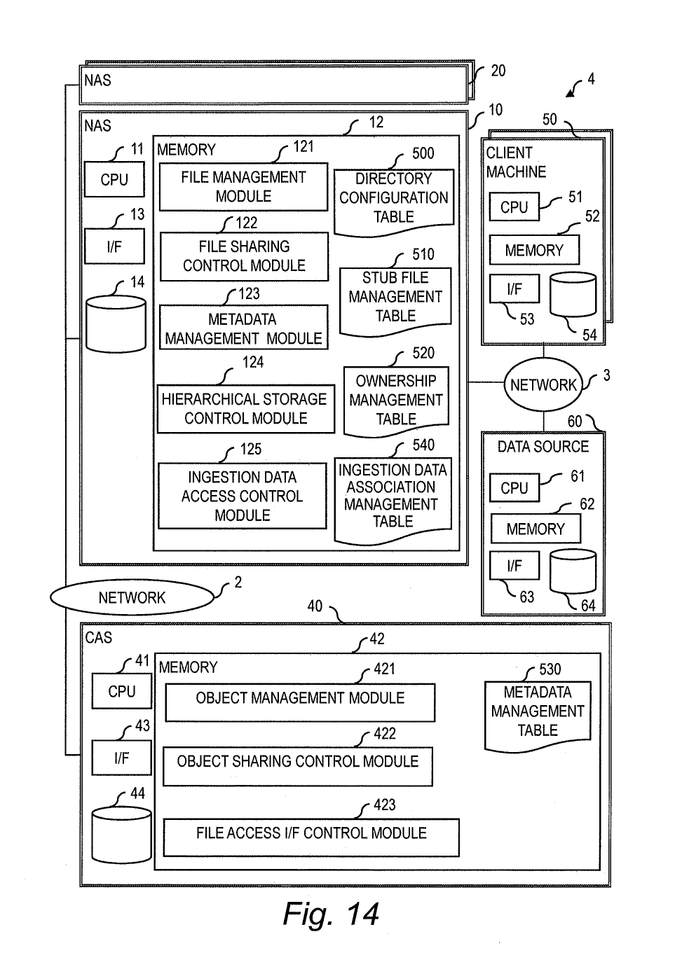

FIG. 14 is a block diagram depicting the configuration of the computer system 4 according to Embodiment 2.

Hereinafter, differences between Embodiment 1 and Embodiment 2 will be mainly explained.

The memory 12 of the NAS 10 according to Embodiment 2 holds the processing modules and information described in Embodiment 1, an ingestion data access control module 125, and an ingestion data association management table 540.

The ingestion data access control module 125 receives an access request for referring to the ingestion data and provides the actual data and metadata in accordance with the access request.

The ingestion data association management table 540 holds information necessary to provide the actual data designated by the access request and the metadata associated with the actual data during the ingestion.

The data source 60 is implemented with a general server computer, for example, and includes CPU 61, memory 62, I/F 63 and auxiliary storage 64. The I/F 63 is an interface for data communication with external apparatuses.

In the memory 62, processing modules are developed by the CPU 61 executing programs. The memory 62 holds a file management module and a data management module (not shown) as processing modules. The file management module is a processing module for providing the file system for holding actual data to be ingested as a file. The data management module is a processing module for holding the database 67 including metadata to be ingested.

The CAS 40 according to Embodiment 2 is the same as the CAS 40 according to Embodiment 1. The client machine 50 according to Embodiment 2 is the same as the client machine 50 according to Embodiment 1.

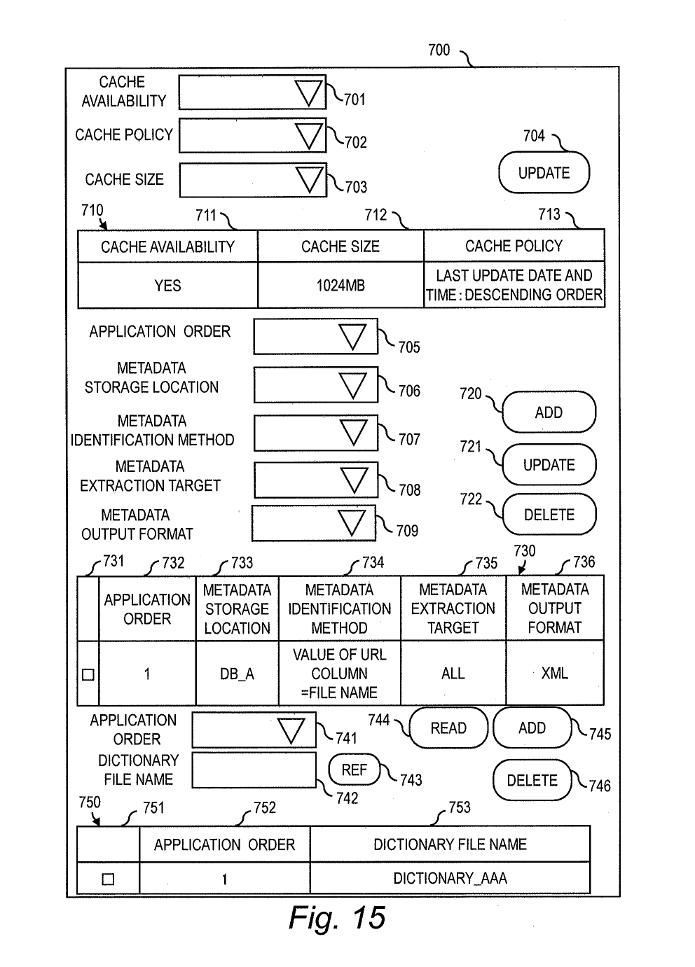

FIG. 15 is an explanatory drawing depicting a management window 700 according to Embodiment 2.

The management window 700 is a window for referring to the settings regarding the access requests for ingestion data and for setting information regarding the access requests. The management window 700 is displayed on a display device of the client machine 50 by the display module (not shown) of the client machine 50.

A user, a system administrator for example, causes the settings regarding reference to ingestion data to be displayed on the management window 700, and adds and modifies the settings on the management window 700. The management window 700 contains a cache information field 710, an ingestion data association field 730, and an ingestion data dictionary field 750.

The management window 700 contains an input field 701, an input field 702, an input field 703, an update button 704, an application order 705, a metadata storage location 706, a metadata identification method 707, a metadata extract target 708, a metadata output format 709, an add button 720, an update button 721, a delete button 722, an application order 741, a dictionary file name 742, a ref button 743, a read button 744, an add button 745 and a delete button 746.

The cache information field 710 displays information regarding the cache provided by the NAS 10. The cache information field 710 contains a cache availability 711, a cache size 712 and a cache policy 713.

The cache availability 711 shows whether the NAS 10 provides the cache for supplying ingestion data with high speed. The cache availability 711 illustrated in FIG. 15 shows “YES” when the cache is provided and “NO” when the cache is not provided.

The cache size 712 shows the cache size provided by the NAS 10 when it is provided.

The cache policy 713 shows the cache control policy when the NAS 10 provides the cache. For example, when a user desires to store the last updated actual data and metadata preferentially, the user registers the policy to store data preferentially in descending order of last update date and time in the cache policy 713.

When a user inputs data to the input field 701, the input field 702 and the input field 703 and presses down the update button 704, the display module displays the information inputted in the cache availability 711, the cache size 712 and the cache policy 713.

The ingestion data association field 730 displays information for locating the area storing the metadata in the data source. The ingestion data association field 730 contains a check field 731, an application order 732, a metadata storage location 733, a metadata identification method 734, a metadata extraction target 735 and a metadata output format 736.

The ingestion data association field 730 displays the contents of the ingestion data association management table 540. The ingestion data association management table 540 held by the NAS 10 contains contents corresponding to the application order 732, the metadata storage location 733, the metadata identification method 734, the metadata extraction target 735 and the metadata output format 736.

The contents of the ingestion data association field 730 and the ingestion data association management table 540 are synchronized by the display module of the client machine 50 and the ingestion data access control module 125 of the NAS 10. When one of the ingestion data association field 730 and the ingestion data association management table 540 is updated, the other is also updated with the updates.

The application order 732 shows the priority order in applying entries. For example, entries are applied in numerical ascending order indicated by the application order 732.

The metadata storage location 733 shows locations storing metadata in the data source 60. For example, metadata is stored in the table 68 of the database 67, the metadata storage location 733 shows the identifier of the database 67.

The metadata identification method 734 shows methods for identifying entries in the areas storing metadata of the data source 60. For example, a URL column storing URLs of actual data files may be included in the table 68 of the database 67 for associating entries of the actual data files and entries of metadata. In this case, the metadata identification method 734 shows a method for identifying an entry the value in the URL column of which coincides with the actual data file name designated in an access request as the metadata designated by the access request.

The metadata extraction target 735 shows information to be provided to a user as metadata from identified entries by the metadata identification method 734. For example, when it is necessary to provide all data of the entries, “ALL” indicating all data is set in the metadata extraction target 735. The metadata extraction target 735 may show any one or more pieces of information.

The metadata output format 736 shows methods for providing information extracted as metadata. For example, when the NAS 10 outputs extracted information in the XLM format, “XLM” is set in the metadata output format 736.

The check field 731 is a region for a user to select a plurality of items.

When a user selects a plurality of boxes in the check field 731 and presses down the delete button, the display module deletes a plurality of entries of the ingestion data association field 730. The ingestion data access control module 125 deletes entries corresponding to the deleted entries in the ingestion data association management table 540.

The management window 700 provides a function to add information to and update the ingestion data association field 730. When a user input data to the application order 705, the metadata storage location 706, the metadata identification method 707, the metadata extract target 708 and the metadata output format 709, and presses down the add button 720, the display module adds the input information to the ingestion data association field 730. The ingestion data access control module 125 stores the information added to the ingestion data association field 730 in the ingestion data association management table 540.

When a user select one box in the check field 731, the display module outputs the information of the selected entry to the application order 705, the metadata storage location 706, the metadata identification method 707, the metadata extract target 708 and the metadata output format 709.

When a user updates the information of the ingestion data association field 730 as necessary and presses down the update button 721, the display module updates the ingestion data association field 730 in accordance with the update result by the user. The ingestion data access control module 125 updates the ingestion data association management table 540 with the updated information in the ingestion data association field 730.

The ingestion data dictionary field 750 shows dictionary files in which the methods for locating the area storing metadata. The ingestion data dictionary field 750 shows dictionary files in which the information indicated by the ingestion data association field 730 and the information indicated by the ingestion data association management table 540.

The window 700 provides a function to register and delete dictionary files. The ingestion data dictionary field 750 contains an application order 752 and a dictionary file name 753.

The application order 752 is the same as the application order 732 in the ingestion data association field 730. The dictionary file name 753 shows the dictionary files containing the information (the metadata storage location 733, the metadata identification method 734, the metadata extraction target 735 and the metadata output format 736) held by the ingestion data association field 730 in specific formats.

The dictionary file according to the present embodiment may hold information in any format which can identify the information shown by the ingestion data association field 730 and be recognized by the NAS 10. The dictionary file may hold information in the XML format, for example.

The window 700 provides a function to add information to and update the ingestion data dictionary field 750. When a user inputs information to the application order 741 and the dictionary file name 742, and presses down the add button 745, the display module adds the input data to the ingestion data dictionary field 750.

A user may use the ref button 743 for inputting information to the dictionary file name 742. When the user presses down the ref button 743, a list of directories of the file system of the client machine 50 may be displayed and the user may select a directory for storing a dictionary file from the list.

When a user selects one box in the check field 751 and presses down the read button 744, the display module displays the contents of the dictionary file. When a user selects one box in the check field 751 and presses down the delete button 746, the display module deletes the selected entry.

The management window 700 illustrated in FIG. 15 is a GUI image. Alternatively, the computer system 4 according to Embodiment 2 may cause a user to set information for referring to ingestion data in any other display method or input method. For example, the client machine 50 or the NAS may output a CLI or an API by a method for program or a command for acquiring, setting and updating information.

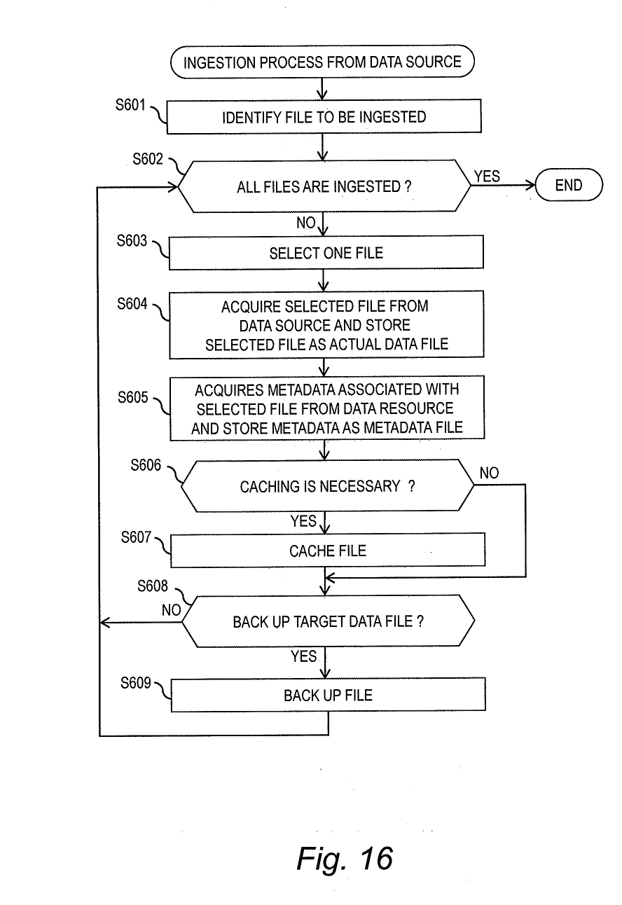

FIG. 16 is a flowchart depicting an ingestion process according to Embodiment 2.

The process illustrated in FIG. 16 is the ingestion process for the NAS 10 to acquire data by requesting the data source 60 to transmit the data. Alternatively, the data source 60 may transmit data without receiving a request from the NAS 10. Either of the NAS 10 or the data source 60 may control the ingestion process. When the NAS 10 controls the ingestion process, the NAS 10 has a server function for ingestion.

The ingestion data access control module 125 performs S601 periodically or in response to an instruction from a user. The ingestion data access control module 125 identifies the file of the data to be ingested in the data source 60 (S601). Specifically, the ingestion data access control module 125 identifies files of data added or updated since the last ingestion process and creates a list indicating the identified files as a list of files to be ingested.

The data source 60 may create a list of files to be ingested periodically or in response to an instruction from a user and transmits the created list to the NAS 10. The NAS 10 may stats the process illustrated in FIG. 16 when the NAS 10 receives the list from the data source 60.

Files identified in S601 are actual data files. When no file to be ingested is identified in S601, the ingestion data access control module 125 may ends the process illustrated in FIG. 16.

After S601, the ingestion data access control module 125 determines whether a file which is not ingested yet by S604 and the subsequent steps is included in the list of files to be ingested (S602). If all the files included in the list of files to be ingested are ingested (S602: Yes), the ingestion data access control module 125 ends the process illustrated in FIG. 16. If the list of files to be ingested includes a file which is not ingested yet (S602: No), the ingestion data access control module 125 performs S603.

In S603, the ingestion data access control module 125 selects a file which is not ingested yet from the list of files to be ingested. After S603, the ingestion data access control module 125 acquires the data of the selected file from the data resource 60 and stores the data in the auxiliary storage 14 of the NAS 10 as an actual data file (S604).

After S604, the ingestion data access control module 125 acquires the metadata associated with the selected file from the data resource 60 and stores the metadata in the auxiliary storage 14 of the NAS 10 as a metadata file (S605). In S605, the ingestion data access control module 125 acquires the storage area of the metadata associated with the selected file and the identification method from the ingestion data association management table 540 using the file name of the selected file. The ingestion data access control module 125 acquires the metadata from the data resource 60 using the acquired storage area and identification method.

After S605, the ingestion data access control module 125 determines whether it is necessary to cache ingestion data (S606). Specifically, when the information in the cache availability 711 of the cache information field 710 indicates utilizing cache, the ingestion data access control module 125 determines that it is necessary to cache ingestion data.

If it is necessary to cache ingestion data (S606: Yes), the ingestion data access control module 125 performs S607. If it is not necessary to cache ingestion data (S606: No), the ingestion data access control module 125 performs S608.

In S607, the ingestion data access control module 125 caches the data acquired from the data source 60 as a file. In S607, the ingestion data access control module 125 caches the file based on the information in the cache size 712 and the cache policy 713 of the cache information field 710. After S607, the ingestion data access control module 125 performs S608.

In S608, the ingestion data access control module 125 determines whether to back up the data of the file selected in S603 to the CAS 40. Specifically, when a policy to perform the backup process after the ingestion process is applied to the computer system in advance, the ingestion data access control module 125 determines to back up the data of the selected file.

The ingestion data access control module 125 may back up data without any condition in the ingestion process. If the ingestion data access control module 125 backs up the data of the selected file (S608: Yes), the ingestion data access control module 125 performs S609. If the ingestion data access control module 125 does not back up the data of the selected file (S608: No), the ingestion data access control module 125 performs S602.

In S609, the ingestion data access control module 125 performs the backup process of the selected file. The ingestion data access control module 125 performs the backup process illustrated in FIG. 8 by input the file name of the selected file to the hierarchical storage control module 124. After the process illustrated in FIG. 8 ends, the ingestion data access control module 125 proceeds to S602 and repeats the steps.

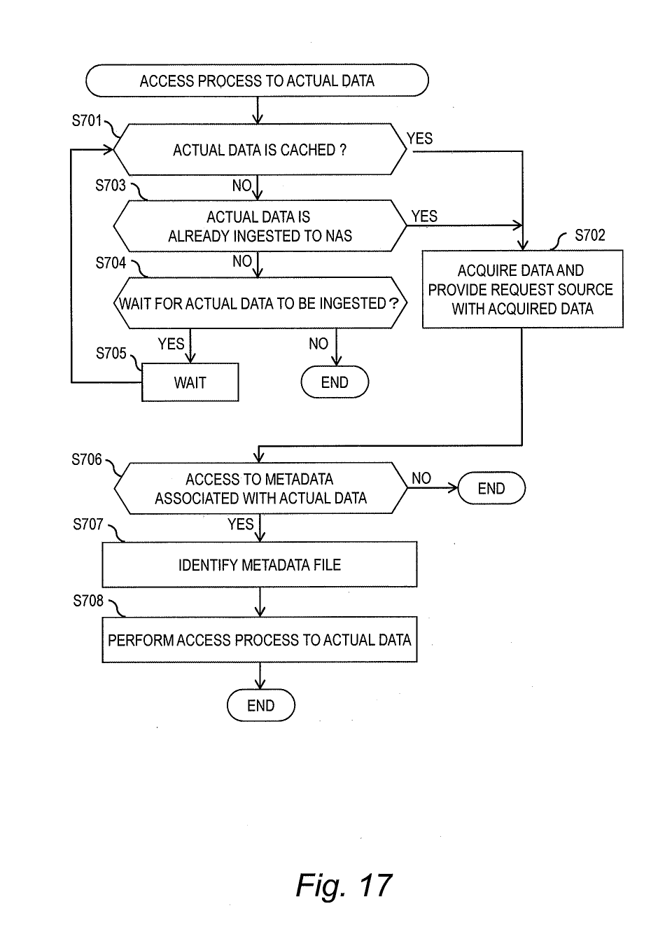

FIG. 17 is a flowchart depicting an access process to actual data according to Embodiment 2.

In the process illustrated in FIG. 17, the NAS 10 receives an access request for referring to actual data being ingested from the client machine 50 during ingestion of the actual data, and the NAS 10 provides the client machine 50 with the requested actual data.

The ingestion data access control module 125 determines whether the actual data (actual data D hereinafter) requested for reference is cached in the NAS 10. If the actual data D is cached (S701: Yes), the ingestion data access control module 125 performs S702. If the actual data D is not cached (S701: No), the ingestion data access control module 125 performs S703.

In S702, the ingestion data access control module 125 acquires the actual data D from the cache or the auxiliary storage 14, and provides the request source with the acquired actual data D via the client machine. When the file backup process of the actual data D is completed, the ingestion data access control module 125 may cause the hierarchical storage control module 124 or other modules to perform the file recall process illustrated in FIG. 9 and acquire the actual data D from the CAS 40.

The ingestion data access control module 125 may provide the acquired actual data after S701, S702 or the process illustrated in FIG. 17. Thus, the ingestion data access control module 125 performs S706 after acquiring the actual data D in S702.

In S703, the ingestion data access control module 125 whether the actual data D is already ingested to the NAS 10. When the actual data D is stored in the auxiliary storage 14, the ingestion data access control module 125 determines that the actual data D is already ingested.

If the actual data D is already ingested (S703: Yes), the ingestion data access control module 125 performs S702. If the actual data D is not ingested yet (S703: No), the ingestion data access control module 125 performs S704.

In S704, the ingestion data access control module 125 determines whether to wait for the end of the ingestion process of the actual data D based on a predetermined policy of the computer system 4. The policy of the computer system 4 may define to wait for the end of the ingestion process of the actual data D or output a failure notice of acquiring the actual data D without waiting for the end of the ingestion process.

When the actual data D is not ingested yet, the ingestion data access control module 125 control the ingestion process such that the actual data D is ingested preferentially. Specifically, the ingestion data access control module 125 may select the file of the actual data D preferentially in S603.

If the ingestion data access control module 125 waits for the end of the ingestion process of the actual data D (S704: Yes), it waits for a predetermined time period in S705. After S705, the ingestion data access control module 125 performs S701. If the ingestion data access control module 125 does not wait for the end of the ingestion process of the actual data D (S704: No), the ingestion data access control module 125 ends the process illustrated in FIG. 17.

In S706, the ingestion data access control module 125 determines whether to refer to the metadata (metadata D hereinafter) associated with the actual data D. Specifically, the ingestion data access control module 125 determines to refer the metadata D when the access request for the actual data D includes access to the metadata D.

If the ingestion data access control module 125 refers to the metadata D (S706: Yes), it performs the S707. If the ingestion data access control module 125 does not refer to the metadata D (S706: No), the ingestion data access control module 125 ends the process illustrated in FIG. 17.

In S707, the ingestion data access control module 125 identifies the metadata file of the metadata D. Specifically, the ingestion data access control module 125 identifies the metadata file of the metadata D by identifying the metadata file from the actual data file name of the actual data D using the directory configuration table 500 of the directory storing the actual data file of the actual data D.

In S707, the ingestion data access control module 125 may identify the metadata file held by the data source 60 using the metadata storage location 733 and the metadata identification method 734 of the ingestion data association management table 540, and the actual data file name of the actual data D.

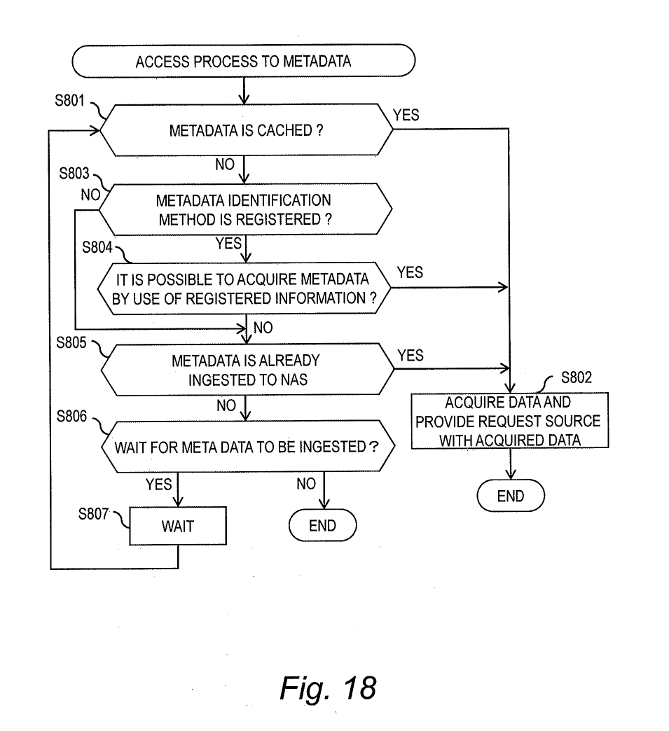

After S707, the ingestion data access control module 125 performs the access process to the metadata D (S708). FIG. 18 depicts the process in S708.

FIG. 18 is a flowchart depicting an access process to metadata according to Embodiment 2.

The process illustrated in FIG. 18 is performed by the NAS 10 when the NAS 10 receives an access request for referring to metadata ingested from the data source 60 via the client machine 50. The process illustrated in FIG. 18 is also performed in S708.

Hereinafter, metadata for which an access request is received and metadata on which the access process is performed in S707 illustrated in FIG. 17 are described as metadata D.

The ingestion data access control module 125 determines whether the metadata D is cached in the NAS 10 (S801). If the metadata D is cached (S801: Yes), the ingestion data access control module 125 performs S802. If the metadata D is not cached (S801: No), the ingestion data access control module 125 performs S803.

In S802, the ingestion data access control module 125 acquires the metadata D from the cache, the data source 60 or the auxiliary storage 14, and provides the access request source with the acquired metadata D. When the file backup process is completed, the ingestion data access control module 125 may cause the hierarchical storage control module 124 or other modules to perform the file recall process illustrated in FIG. 9 and acquire the metadata D from the CAS 40.

The ingestion data access control module 125 may provide the metadata D after S801, S804, S805 or the process illustrated in FIG. 18. After S803, the ingestion data access control module 125 ends the process illustrated in FIG. 18.

In S803, the ingestion data access control module 125 determines whether a method for identifying metadata (corresponding to the metadata identification method 734 of the ingestion data association field 730) is registered in the ingestion data association management table 540. If a method for identifying metadata is registered (S803: Yes), the ingestion data access control module 125 performs S804. If a method for identifying metadata is not registered (S803: No), the ingestion data access control module 125 performs S805.

In S804, the ingestion data access control module 125 determines whether it is possible to acquire the metadata D from the data source 60 using the registered metadata identification method. For example, if the registered metadata identification method uses the actual data file name as an argument and the ingestion data access control module 125 does not received the actual data file name of the actual data associated with the metadata D in S804, the ingestion data access control module 125 determines that the it is impossible to acquire the metadata D from the data source 60.

If it is possible to acquire the metadata D from the data source 60 (S804: Yes), the ingestion data access control module 125 performs S802. If it is impossible to acquire the metadata D from the data source 60 (S804: No), the ingestion data access control module 125 performs S805.

In S805, the ingestion data access control module 125 determines whether the metadata D is already ingested to the NAS 10. Specifically, when the metadata file of the metadata D is stored in the auxiliary storage 14, the ingestion data access control module 125 determines that the metadata D is already ingested. If the metadata D is already ingested (S805: Yes), the ingestion data access control module 125 performs S802. If the metadata D is not ingested yet (S805: No), the ingestion data access control module 125 performs S806.

In 806, the ingestion data access control module 125 determines whether to wait for the end of the ingestion process of the metadata D based on a predetermined policy of the computer system 4. The policy of the computer system 4 may define to wait for the end of the ingestion process of the metadata D or output a failure notice of acquiring the metadata D without waiting for the end of the ingestion process.

When the ingestion data access control module 125 holds the actual data name of the actual data associated with the metadata D, it may control the ingestion process such that the metadata D is ingested preferentially. Specifically, the ingestion data access control module 125 may select the file of the actual data associated with the metadata D preferentially in S603.

If the ingestion data access control module 125 waits for the end of the ingestion process of the metadata D (S806: Yes), the ingestion data access control module 125 waits for a predetermined time period in S807. After S807, the ingestion data access control module 125 performs S801. If the ingestion data access control module 125 does not wait for the end of the ingestion process of the metadata D (S806: No), the ingestion data access control module 125 ends the process illustrated in FIG. 18.

As described above, the computer system 4 according to Embodiment 2 allows the data ingested from the data source 60 to be provided to the access request source. Further, the computer system 4 according to Embodiment 2 allows the file of the ingestion data to be referred quickly when an access request for the actual data or metadata of the ingestion data is issued during the ingestion of the data from the data source 60.

This allows a user to refer to the data during the ingestion process when it takes long time to ingest a large amount of data from the data source 60 to the NAS 10. This results in the reduction of effect of the ingestion process to operations utilizing data.

The present invention is not limited to the above-described embodiments but includes various modifications. The above-described embodiments are explained in details for better understanding of this invention and are not limited to those including all the configurations described above.

A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions.

The process modules in the NASs and the CAS 40 according to the present embodiments may be divided for processes. For example, the hierarchical storage control module 124 may include two modules for the file backup process illustrated in FIG. 8 and the file recall process illustrated in FIG. 9, respectively.

The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected

The present invention allows a computer system in which actual data is shared among a plurality of sites to manage the actual data and the associated metadata as files in a site and maintain and restore the association in another site. The present invention allows the computer system to add simultaneously and concurrently individual pieces of metadata associated with a piece of actual data at sites. This allows a plurality of sites to extract pieces of metadata for a piece of actual data and register various pieces of metadata for a piece of metadata, resulting in an increase in the flexibility of system configuration regarding the extraction of metadata.

Further, the present invention facilitates metadata created at one site to be shared with another site. This facilitates an environment to extract metadata and an environment to search or analyze using the metadata to connect with each other and exist together. Further, this decreases overhead and computer resources for sharing data, and contributes to effective utilization of resources of the system.

What is claimed is:

1. A data management system for managing data stored in computers comprising:
a plurality of first computers comprising first processors and first storage units; and
a second computer comprising a second processor and a second storage unit,
wherein the second storage unit is configured to store a first piece of data and a plurality of second pieces of data,
wherein each of the first storage units is configured to hold configuration information indicating association between the first piece of data and the plurality of second pieces of data associated by the plurality of first computers,
wherein each of the first computers is configured to receive a second piece of data and register information of the received second piece of data in the configuration information,
wherein each of the first computers is configured to instruct the second computer to store the received second piece of data in association with the first piece of data,
wherein the second computer is configured to, in accordance with instructions from the plurality of first computers, store the plurality of second pieces of data in the second storage unit in association with the first piece of data, and
wherein, each of the first computers is configured to identify a second piece of data to be acquired from the second computer based on the configuration information in acquiring the second piece of data.

2. The data management system according to claim 1,
wherein the second computer is configured to store a file object containing the first piece of data and the associated plurality of second pieces of data in the second storage unit in accordance with instructions from the plurality of first computers,
wherein the second computer is configured to store a directory object indicating the first piece of data and the plurality of second pieces of data contained in the second storage unit in the second storage unit, and
wherein each of the first computers is configured to update the configuration information based on the directory object.

3. The data management system according to claim 2,
wherein each of the first computers is configured to hold an authority management table indicating the directory object which each of the first computers has an authority to update, and
wherein each of the first computers is configured to instruct the second computer to update the directory object which each of the first computers has the authority to update, based on the plurality of second pieces of data contained in the file object in accordance with the authority management table.

4. The data management system according to claim 2,
wherein each of the first computers is configured to create a first file used for accessing the first piece of data and a second file used for accessing one of the second pieces of data,
wherein each of the first computers includes an interface for receiving a designation of the first file,
wherein each of the first computers is configured to identify a file object to be accessed using the designated first file when a first computer which receives the designation does not hold the first file, and
wherein each of the first computers is configured to create the designated first file based on the identified file object.

5. The data management system according to claim 1, further comprising a third computer configured to store the first piece of data and the plurality of second pieces of data,
wherein each of the first computers includes an interface for receiving an access request for the first piece of data or one of the second pieces of data, and
wherein each of the first computers is configured to output the access requested first piece of data or one of the second pieces of data after acquiring the first piece of data and the plurality of second pieces of data from the third computer.

6. The data management system according to claim 5,
wherein each of the first computers is configured to instruct the second computer to store the plurality of second pieces of data acquired from the third computer in association with the first piece of data and acquired from the third computer after acquiring the first piece of data and the plurality of second pieces of data, and
wherein each of the first computers is configured to acquire the access requested first piece of data or one of the plurality of second pieces of data from the second computer,
wherein each of the first computers is configured to output the first piece of data or the one of the plurality of second pieces of data acquired from the second computer.

7. The data management system according to claim 5,
wherein each of the first computers includes a cache,
wherein each of the first computers is configured to store the first piece of data and the plurality of second pieces of data in the cache, and
wherein each of the first computers is configured to output one of the first piece of data and the plurality of second pieces of data in the cache.

8. The data management system according to claim 5,
wherein each of the first computers is configured to hold identification information indicating a method for identifying the plurality of second pieces of data held by the third computer from an identifier of the first piece of data, and
wherein each of the first computers is configured to, when acquisition of the second pieces of data from the third computer is not completed, based on the identifier of the access requested first piece of data and the identification information acquire the access requested one of the plurality of second pieces of data from the third computer.

9. A data management method performed by a computer system,
wherein the computer system comprises a plurality of first computers and a second computer,
wherein the plurality of first computers includes first processors and first storage units,
wherein the second computer includes a second processor and a second storage unit,
wherein the second storage unit is configured to store a first piece of data and a plurality of second pieces of data, and
wherein each of the first storage units is configured to hold configuration information indicating association between the first piece of data and the plurality of second pieces of data associated by the plurality of first computers,
the data management method comprising:
receiving, by each of the first processors, a second piece of data and register information of the received second piece of data in the configuration information,
instructing, by each of the first processors, the second computer to store the received second piece of data in association with the first piece of data,
storing, by the second processor, in accordance with instructions from the plurality of first computers, the plurality of second pieces of data in the second storage unit in association with the first piece of data, and
identifying, by each of the first processors, a second piece of data to be acquired from the second computer based on the configuration information in acquiring the second piece of data.

10. The data management method according to claim 9, further comprising:
storing, by the second processor, a file object containing the first piece of data and the associated plurality of second pieces of data in the second storage unit in accordance with instructions from the plurality of first computers,
storing, by the second processor, a directory object indicating the first piece of data and the plurality of second pieces of data contained in the second storage unit in the second storage unit, and
updating, by each of the first processors, the configuration information based on the directory object.

11. The data management method according to claim 10,
wherein each of the first computers is configured to hold an authority management table indicating the directory object which each of the first computers has an authority to update,
the data management method further comprising
instructing, by each of the first processors, the second computer to update the directory object which each of the first computers has the authority to update, based on the plurality of second pieces of data contained in the file object in accordance with the authority management table.

12. The data management method according to claim 10,
wherein each of the first computers is configured to create a first file used for accessing the first piece of data and a second file used for accessing one of the second pieces of data, and
wherein each of the first computers includes an interface for receiving a designation of the first file,
the data management method further comprising:
identifying, by each of the first processors, a file object to be accessed using the designated first file when a first computer which receives the designation does not hold the first file; and
creating, by each of the first processors, the designated first file based on the identified file object.

13. The data management method according to claim 9,
wherein the computer system comprises a third computer configured to store the first piece of data and the plurality of second pieces of data, and
wherein each of the first computers includes an interface for receiving an access request for the first piece of data or one of the second pieces of data,
the data management method further comprising
outputting, by each of the first processors, the access requested first piece of data or one of the second pieces of data after acquiring the first piece of data and the plurality of second pieces of data from the third computer.

14. The data management method according to claim 13, further comprising:
Instructing, by each of the first processors, the second computer to store the plurality of second pieces of data acquired from the third computer in association with the first piece of data and acquired from the third computer after acquiring the first piece of data and the plurality of second pieces of data, and
acquiring, by each of the first processors, the access requested first piece of data or one of the plurality of second pieces of data from the second computer,
outputting, by each of the first processors, the first piece of data or the one of the plurality of second pieces of data acquired from the second computer.

15. The data management method according to claim 13,
wherein each of the first computers includes a cache,
the data management method further comprising:
storing, by each of the first processors, the first piece of data and the plurality of second pieces of data in the cache, and
outputting, by each of the first processors, one of the first piece of data and the plurality of second pieces of data in the cache.
